(19) United States
(12) Patent Application Publication
(10) Pub. No.: US 2017/0011432 A1
(43) Pub. Date: Jan. 12, 2017

(54) ADVERTISEMENT TRANSMISSION SERVICE PROVIDING DEVICE, USER EQUIPMENT, LOG STORING AND LANDING SERVICE PROVIDING DEVICE, ADVERTISING PLATFORM, ADVERTISING SYSTEM COMPRISING THE SAME, CONTROL METHOD THEREOF AND NON-TRANSITORY COMPUTER READABLE STORAGE MEDIUM HAVING COMPUTER PROGRAM RECORDED THEREFOR

(71) Applicant: SK Planet Co., Ltd., Seongnam-si (KR)

(72) Inventors: Min Ho HAN, Seoul (KR); Sang Mok SOHN, Seongnam-si (KR)

(21) Appl. No.: 15/201,596

(22) Filed: Jul. 4, 2016

(30) Foreign Application Priority Data
Jul. 6, 2015 (KR) 10-2015-0096135
Dec. 18, 2015 (KR) 10-2015-0181819

(51) Int. Cl. G06Q 30/02; H04L 29/12

(52) U.S. Cl. CPC G06Q 30/0277; H04L 61/3025; G06Q 30/0257

(57) ABSTRACT

Disclosed are an advertisement transmission service providing device, user equipment, a log storing and landing service providing device, an advertising platform, an advertising system comprising the same, a control method thereof, and a non-transitory computer readable storage medium having computer program recorded therefor. The present invention can protect user equipment from modification of advertisement information or infection with malicious codes through hacking and provide advertisement information having reliability so as not to expose a landing address through the advertisement information.

### CROSS-REFERENCE TO RELATED APPLICATION

This application claims the benefit of Korean Application Nos. 10-2015-0096135 filed on Jul. 6, 2015 and 10-2015-0181819 filed on Dec. 18, 2015 with the Korean Intellectual Property Office, the disclosure of which is incorporated herein by reference.

### BACKGROUND OF THE INVENTION

1. Field of the Invention

The present invention relates to an advertisement transmission service providing device, user equipment, a log storing and landing service providing device, an advertising platform, an advertising system comprising the same, a control method thereof, and a non-transitory computer readable storage medium having computer program recorded therefor. More particularly, the present invention relates to a an advertisement transmission service providing device, user equipment, a log storing and landing service providing device, an advertising platform, an advertising system comprising the same, a control method thereof, and a non-transitory computer readable storage medium having computer program recorded therefor, which provides advertisement information and a unique ID of the advertisement information corresponding to a landing address to the user equipment instead of directly transmitting the landing address together with the advertisement information to the user equipment requesting an advertisement, transmits a selected unique ID of the advertisement information when the unique ID of the advertisement information is selected in the corresponding user equipment to the log storing and landing service providing device, and redirects the corresponding user equipment from the corresponding log storing and landing service providing device to the landing address corresponding to the unique ID of the advertisement information.

2. Description of the Related Art

An advertisement platform is a kind of advertisement agency business that holds an advertisement exposed through a mobile application or a mobile web to provide the advertisement to an application developer.

When user equipment included in an advertising system requests the advertisement to the service providing device, the corresponding user equipment receives advertisement information transmitted from the service providing device, a landing address to be landed to an advertiser page, and the like, and accesses the corresponding advertiser page when the received landing address is selected by the user of the user equipment.

In the advertising system, in most cases where the landing address is directly authored together on an HTML code or received and processed from the service providing device as a parameter, a case of inducing landing to a gateway service providing device infected with a malicious code or virus through a page change using security vulnerability according to a browser by hackers is generated and a risk that may be infected with virus or a malicious code is present in the corresponding user equipment receiving the advertisement.

Further, in the advertisement platform, a banner advertisement has been provided to an application or a web browser. However, a click rate of the banner advertisement is steadily and rapidly decreased and currently recorded at an average 0.1%. The number of average monthly banner advertisements which are met by the user through the web surfing is 1,707. However, a probability that the user clicks the banner advertisement is approximately 475 times higher than a probability that the user survives a plane crash. A probability that the user clicks the banner advertisements which are spread all over the news page is approximately 297 times higher than a probability that the user climbs the Mount Everest to climb to the top. Easy to talk, the banner advertisements are not effective. For this reason, recently, native advertising has been provided.

The native advertising means that the advertiser runs the advertisement in a purchased medium and provides the advertisement in a range where a form of the advertisement damages a form and a function of the medium. Recently, most of platforms and publishers commonly determine the native advertising in the entire industry direction and traditional published media such as facebook and twitter follow this trend. For example, Time, Forbes, WSJ, NewYork Times, and the like provide the native advertising based on the form and the function in theirs sites.

In terms of the native advertising network business, many obstacles are generated and thus there are many difficulties in the advertising industry. For example, in a limitation of providing the native advertising to a form (a size, a context, and the like) suitable for the medium and an ID system collecting method for a user analysis, the native advertising is commonly stored in a storage medium such as a SD card to be utilized in various apps. However, advertisement-related id values are deleted by a clean app or a cookies value is erased through private browsing and the like, and thus there is difficulty in accurate targeting to the customer. Further, in order to provide various mediums and requirements of the advertiser, advertising organization, correction, and transmission logic are gradually complicated and diversified, and thus there is a limit to a lot of operation development costs and the like.

### PATENT DOCUMENT

Korean Patent Publication No. 10-2012-0136619, titled “An access control system and an access control method controlling access to a landing page by using a multidimensionality code, and a user terminal system and an access method accessing the landing page by using the multidimensionality code”

### SUMMARY OF THE INVENTION

An object of the present invention is to provide an advertisement transmission service providing device, user equipment, a log storing and landing service providing device, an advertising platform, an advertising system comprising the same, a control method thereof, and a non-transitory computer readable storage medium having computer program recorded therefor, which provide advertisement information and a unique ID of the advertisement information corresponding to a landing address to the user equipment instead of directly transmitting the landing address together with the advertisement information to the user equipment requesting an advertisement.

Another object of the present invention is to provide an advertisement transmission service providing device, user equipment, a log storing and landing service providing device, an advertising platform, an advertising system comprising the same, a control method thereof, and a non-transitory computer readable storage medium having computer program recorded therefor, which transmit a selected unique ID of the advertisement information when the unique ID of the advertisement information is selected in the corresponding user equipment to the log storing and landing service providing device, and redirect the corresponding user equipment from the corresponding log storing and landing service providing device to the landing address corresponding to the unique ID of the advertisement information.

Yet another object of the present invention is to provide an advertising system, a control method thereof, and a non-transitory computer readable storage medium having computer program recorded therefor, which provide native advertising in a range without damaging a form and a function of its medium.

Still another object of the present invention is to provide an advertising system, a control method thereof, and a non-transitory computer readable storage medium having computer program recorded therefor, which exchanges native advertising in a range without damaging a form and a function of its medium between advertising platforms.

Still yet another object of the present invention is to provide an advertising system, a control method thereof, and a non-transitory computer readable storage medium having computer program recorded therefor, which are constituted by allowing the advertising platform to ensure behavior information in the advertising platform without using user's agreement to information application for a user behavior analysis for providing the advertisement.

Still yet another object of the present invention is to provide an advertising system, a control method thereof, and a non-transitory computer readable storage medium having computer program recorded therefor, which exchange an advertisement by using an adhoc-network between the advertising platforms.

Still yet another object of the present invention is to provide an advertising system, a control method thereof, and a non-transitory computer readable storage medium having computer program recorded therefor, which perform settlement through settlement API call between the advertising platforms.

According to an aspect of the present invention, an advertising system controlling access to a landing page may include: an advertisement database storing a plurality of advertisement information; an advertisement scheduling service providing device which matches a landing address for advertisement information with a unique ID of the advertisement information corresponding to advertisement information stored in the advertisement database, stores the matched landing address for each unique ID in a landing address cache database, and transmits advertisement volume information, the plurality of advertisement information, and unique IDs for the plurality of advertisement information; an advertisement transmission service providing device which stores the advertisement volume information, the plurality of advertisement information, and the unique IDs for the plurality of advertisement information which are transmitted from the advertisement scheduling service providing device and transmits, to the user equipment, one or more advertisement information among the plurality of prestored advertisement information and unique IDs corresponding to the one or more advertisement information, respectively, in response to an advertisement request signal transmitted from the user equipment; user equipment which displays one or more advertisement information and unique IDs corresponding to the one or more advertisement information, respectively, which are transmitted from the advertisement transmission service providing device in response to the advertisement request signal and transmits a selected unique ID of the specific advertisement information and identification information of the user equipment when a unique ID of specific advertisement information is selected from the unique IDs corresponding to the one or more advertisement information; and a log storing and landing service providing device which redirects the user equipment to the landing address corresponding to the unique ID of the specific advertisement information transmitted from the user equipment by interlocking with the landing address cache database.

In an embodiment of the present invention, the advertisement transmission service providing device may verify one or more advertisement information based on predetermined advertisement scheduling information among the plurality of prestored advertisement information, verify a unique ID corresponding to each of the verified one or more advertisement information, and transmit, to the user equipment, the verified one or more advertisement information and the unique ID corresponding to each of one or more advertisement information.

In an embodiment of the present invention, the log storing and landing service providing device may verify the landing address corresponding to the unique ID of the specific advertisement information which is transmitted from the user equipment among the landing addresses for the plurality of unique IDs prestored in the landing address cache database.

In an embodiment of the present invention, the log storing and landing service providing device may redirect the user equipment to the verified landing address to access the user equipment to an advertiser service providing device corresponding to the landing address.

According to another aspect of the present invention, a control method for an advertising system controlling access to a landing page includes: matching, by an advertisement scheduling service providing device, a landing address for advertisement information with a unique ID of the advertisement information corresponding to advertisement information stored in the advertisement database; storing, by the advertisement scheduling service providing device, the matched landing address for each unique ID in a landing address cache database; transmitting, by the advertisement scheduling service providing device, advertisement volume information, the plurality of advertisement information, and unique IDs for the plurality of advertisement information; storing, by an advertisement transmission service providing device, the advertisement volume information, the plurality of advertisement information, and the unique IDs for the plurality of advertisement information which are transmitted from the advertisement scheduling service providing device; transmitting, by the advertisement transmission service providing device, to the user equipment, one or more advertisement information among the plurality of prestored advertisement information and unique IDs corresponding to the one or more advertisement information in response to an advertisement request signal transmitted from the user equipment; and displaying, by the user equipment, one or more advertisement information and unique IDs corresponding to the one or more advertisement information, which are transmitted from the advertisement transmission service providing device in response to the advertisement request signal.

In an embodiment of the present invention, the control method may further include: transmitting, by the user equipment, a selected unique ID of the specific advertisement information and identification information of the user equipment when a unique ID of specific advertisement information is selected from the unique IDs corresponding to one or more advertisement information; and redirecting, by a log storing and landing service providing device, the user equipment to the landing address corresponding to the unique ID of the specific advertisement information transmitted from the user equipment by interlocking with the landing address cache database.

In an embodiment of the present invention, the transmitting of the one or more advertisement information and unique IDs corresponding to the one or more advertisement information to the user equipment may include: verifying, by the advertisement transmission service providing device, one or more advertisement information based on predetermined advertisement scheduling information among the plurality of prestored advertisement information; verifying, by the advertisement transmission service providing device, a unique ID corresponding to each of the verified one or more advertisement information; and transmitting, by the advertisement transmission service providing device, to the user equipment, the verified one or more advertisement information and the unique ID corresponding to each of one or more advertisement information.

In an embodiment of the present invention, the redirecting of the user equipment may include: verifying, by the log storing and landing service providing device, the landing address corresponding to the unique ID of the specific advertisement information which is transmitted from the user equipment among the landing addresses for the plurality of unique IDs prestored in the landing address cache database; and redirecting, the log storing and landing service providing device, the user equipment to the verified landing address to access the user equipment to an advertiser service providing device corresponding to the landing address.

According to yet another aspect of the present invention, a computer program executing the methods according to the aforementioned embodiments may be stored in a non-transitory computer readable storage medium having a computer program recorded thereon.

According to still another aspect of the present invention, an advertising platform includes: an advertising platform information registering unit which arranges router information for another adjacent advertising platform according to a predetermined priority to register the router information on a routing table; an advertisement request information receiving unit which receives advertisement request information from the other advertising platform; and an advertisement providing unit which provides the advertisement to user equipment according to the advertisement request information.

In an embodiment of the present invention, the advertising platform may further include: an advertisement destination comparing unit which compares an advertisement transfer destination and departure point between the advertising platforms; an advertisement verifying unit which verifies whether there is an advertisement to be provided according to the advertisement request information received from the advertisement request information receiving unit; an advertisement request information transferring unit which transfers the advertisement request information to another advertising platform; and an advertisement transfer information transmitting unit which transmits the information transferred by the advertisement request information transferring unit to an advertisement exchange information managing device.

In an embodiment of the present invention, the advertising platform may be connected with another adjacent advertising platform by an adhoc-network.

In an embodiment of the present invention, the advertising platform information registering unit may register router information of another advertising platform on a routing table when a size of the advertisement held by the advertising platform requesting the advertisement coincides with a size of the advertisement held by another advertising platform.

In an embodiment of the present invention, the advertising platform information registering unit may register the router information of another advertising platform on the routing table, when it is verified in the advertisement destination comparing unit that the transfer destination of the advertising platform and the departure point of the other advertising platform are not the same as each other.

In an embodiment of the present invention, the advertisement request information transferring unit may transfer the advertisement request information to the other advertising platform according to the routing table priority when it is verified in the advertisement verifying unit that there is no advertisement to be provided.

In an embodiment of the present invention, the advertisement providing unit may provide the advertisement according to the advertisement request information when it is verified in the advertisement verifying unit that there is the advertisement to be provided.

In an embodiment of the present invention, the advertisement providing unit may provide the advertisement when a category value of the advertisement to be provided and a category value included in the user coincide with each other.

In an embodiment of the present invention, the advertisement providing unit may provide the advertisement when a category value of the advertisement to be provided and a category value of a medium coincide with each other.

In an embodiment of the present invention, the advertising platform information registering unit may measure a network response time of other adjacent advertising platforms every predetermined period and sequentially register router information of other adjacent advertising platforms on the routing table according to the response time.

According to the present invention, it is possible to improve operating efficiency of the advertising system according to a simple protocol, by providing advertisement information and a unique ID of the advertisement information corresponding to a landing address to the user equipment instead of directly transmitting the landing address together with the advertisement information to the user equipment requesting an advertisement.

Further, it is possible to protect the user equipment from modification of the advertisement information or infection of the malicious code through hacking by preventing the landing address from being exposed through the advertisement information and provide advertisement information having high reliability, by transmitting a selected unique ID of the advertisement information when the unique ID of the advertisement information is selected in the corresponding user equipment to the log storing and landing service providing device, and redirecting the corresponding user equipment from the corresponding log storing and landing service providing device to the landing address corresponding to the unique ID of the advertisement information.

Further, it is possible to naturally provide the advertisement according to a medium in an application by providing native advertising in a range without damaging a form and a function of its medium of the advertising platform.

Further, it is possible to solve an advertisement shortage of each advertising platform by exchanging native advertising in a range without damaging a form and a function of its medium between advertising platforms.

Further, it is possible to ensure behavior information in the advertising platform, without using user's agreement to information application for a user behavior analysis for providing the advertisement in the advertising platform.

Further, it is possible to exchange the advertisement, by using an adhoc-network between the advertising platforms. Further, it is possible to perform settlement through settlement API call between the advertising platforms.

### BRIEF DESCRIPTION OF THE DRAWINGS

FIG. 1 is a block diagram illustrating a configuration of an advertising system according to an embodiment of the present invention.

FIG. 2 is a block diagram illustrating a configuration of user equipment according to an embodiment of the present invention.

FIG. 3 is a flowchart illustrating a control method of an advertising system which controls access to a landing page according to a first embodiment of the present invention.

FIG. 4 is a diagram illustrating a screen of user equipment according to the first embodiment of the present invention.

FIG. 5 is a flowchart illustrating a control method of an advertisement scheduling service providing device according to a second embodiment of the present invention.

FIG. 6 is a flowchart illustrating a control method of an advertisement transmission service providing device according to a third embodiment of the present invention.

FIG. 7 is a flowchart illustrating a control method of user equipment according to a fourth embodiment of the present invention.

FIG. 8 is a flowchart illustrating a control method of a log storing and landing service providing device according to a fifth embodiment of the present invention.

FIG. 9 is a block diagram illustrating a configuration an advertising system which provides an advertisement exchange service between the advertising platforms according to an embodiment of the present invention.

FIG. 10 is a block diagram illustrating a configuration of an advertising platform according to an embodiment of the present invention.

FIG. 11 is a block diagram illustrating a configuration of an advertisement exchange information managing device according to an embodiment of the present invention.

FIG. 12 is a block diagram illustrating a configuration of an advertisement information settlement device according to an embodiment of the present invention.

FIG. 13 is a flowchart illustrating an advertisement providing method of an advertising platform according to a request of user equipment according to an embodiment of the present invention.

FIG. 14 is a flowchart illustrating a method of arranging a routing table in an advertising platform according to an embodiment of the present invention.

FIG. 15 is a flowchart illustrating a method of exchanging an advertisement between advertising platforms according to an embodiment of the present invention.

FIG. 16 is a flowchart illustrating a method of providing an advertisement exchange service between advertising platforms according to an embodiment of the present invention.

### DETAILED DESCRIPTION OF THE EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not included or additional components or steps may be further included. In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

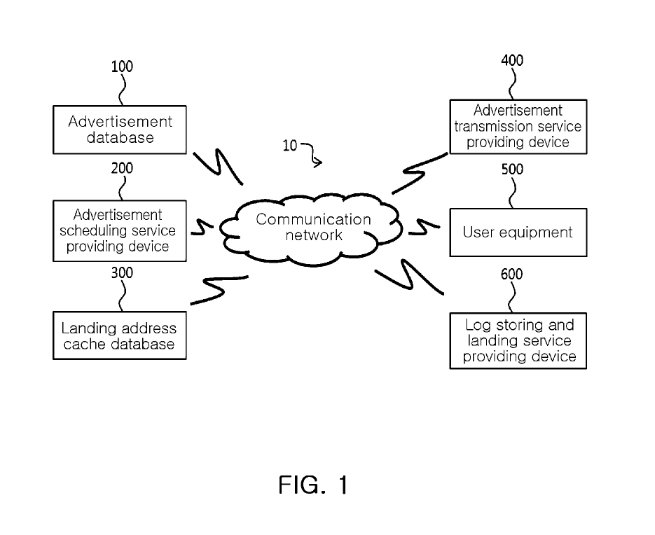

FIG. 1 is a block diagram illustrating a configuration of an advertising system 10 according to an embodiment of the present invention.

As illustrated in FIG. 1, the advertising system 10 includes an advertisement database 100, an advertisement scheduling service providing device 200, a landing address cache database 300, an advertisement transmission service providing device 400, user equipment 500, and a log storing and landing service providing device 600. All the components of the advertising system 10 illustrated in FIG. 1 are not required components, and the advertising system may be implemented by more components than the components illustrated in FIG. 1 or less components therethan.

The advertisement scheduling service providing device 200 matches a landing address for advertisement information with a unique ID of advertisement information corresponding to the corresponding advertisement information with respect to a plurality of advertisement information stored in the advertisement database 100 and then stores the matched information (a landing address for each unique ID of the advertisement information) in the landing address cache database 300. Thereafter, the advertisement scheduling service providing device 200 transmits advertisement volume information, advertisement information, a unique ID of the advertisement information, and the like to the advertisement transmission service providing device 400. Thereafter, the advertisement transmission service providing device 400 provides at least one advertisement information, a unique ID of the advertisement information corresponding to the corresponding advertisement information, and the like to the user equipment 500, in a plurality of advertisement information prestored in response to an advertisement request signal transmitted from the user equipment 500. Thereafter, when a unique ID of specific advertisement information is selected from unique IDs of at least one advertisement information displayed on the user equipment 500, the user equipment 500 transmits the unique ID of the selected specific advertisement information, identification information of the user equipment, and the like to the log storing and landing service providing device 600. Thereafter, the log storing and landing service providing device 600 verifies a landing address corresponding to the unique ID of the specific advertisement information in landing addresses for a plurality of unique IDs prestored in the landing address cache database 300. Thereafter, the log storing and landing service providing device 600 redirects the corresponding user equipment 500 to the verified landing address to access the user equipment to the advertiser service providing device corresponding to the corresponding landing address.

The advertisement database 100 stores (alternatively, manages) the plurality of (alternatively, one or more) advertisement information transmitted from a plurality of advertiser terminals (not illustrated) owned by a plurality of advertisers. Herein, the advertisement information may be a multimedia content form, and includes information regarding at least one store related with the advertiser, at least one product, and the like.

The advertisement scheduling service providing device 200 communicates with the advertisement database 100, the landing address cache database 300, the advertisement transmission service providing device 400, and the like.

Further, the advertisement scheduling service providing device 200 includes a communication unit (not illustrated) which communicates with any internal component or at least one external terminal via the wired/wireless communication network. In this case, any external terminal may include the advertisement database 100, the landing address cache database 300, the advertisement transmission service providing device 400, and the like. Herein, a wireless Internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS), or the like, and the communication unit transmits and receives data according to at least one wireless Internet technique in a range including internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Further, the wired communication technique may include power line communication (PLC), USB communication, Ethernet, serial communication, optical/coaxial cable, or the like.

Further, the communication unit may transmit the information with any terminal through a universal serial bus (USB).

Further, the advertisement scheduling service providing device 200 may also perform a scheduling function for the plurality of advertisement information stored in the advertisement database 100.

Further, the advertisement scheduling service providing device 200 matches the landing address for the corresponding advertisement information with the unique ID (alternatively, a unique key value) of the advertisement information corresponding to the advertisement information, with respect to the plurality of advertisement information stored in the advertisement database 100. In this case, the unique ID corresponding to the advertisement information may be set by the advertisement scheduling service providing device 200 and may be in a preset state when the corresponding advertisement information is updated in the advertisement database 100. Further, the unique ID (alternatively, a unique ID for each advertisement information) is information matched with the landing address.

Further, the advertisement scheduling service providing device 200 stores the matched information (alternatively, a landing address for each unique ID of the matched advertisement information/a landing address for each matched unique ID) in the landing address cache database 300.

That is, the advertisement scheduling service providing device 200 stores the corresponding matched information in the landing address cache database 300 as a Hash Map-based data structure in which the unique ID is set as a key and the landing address (alternatively, a landing URL) is set as a value.

Further, the advertisement scheduling service providing device 200 transmits advertisement volume information, a plurality of advertisement information, unique IDs of the plurality of advertisement information, and the like to the advertisement transmission service providing device 400.

That is, the advertisement scheduling service providing device 200 transmits the plurality of advertisement information, unique IDs of the plurality of advertisement information, advertisement volume information, and the like stored in the advertisement database 100, to the advertisement transmission service providing device 400.

The landing address cache database 300 communicates with the advertisement scheduling service providing device 200, the log storing and landing service providing device 600, and the like.

Further, the landing address cache database 300 stores (alternatively, manages) the matched information (alternatively, the landing address for each unique ID of the matched advertisement information/the landing address for each matched unique ID) in the advertisement scheduling service providing device 200, by a control of the advertisement scheduling service providing device 200. Further, the unique ID (alternatively, the unique ID for each advertisement information) is information matched with the landing address.

Further, the landing address cache database 300 provides a reading function for the landing address corresponding to the unique ID of the specific advertisement information in the prestored landing address for each unique ID (alternatively, the landing address for each unique ID of the advertisement information), by a control of the log storing and landing service providing device 600.

The advertisement transmission service providing device 400 communicates with any internal component or at least any one external terminal via a wired/wireless communication network. In this case, any external terminal may include the advertisement scheduling service providing device 200, the user equipment 500, and the like. Herein, the wireless Internet technology includes WLAN, DLNA, Wibro, Wimax, HSDPA, HSUPA, IEEE 802.16, long term evolution (LTE), LTE-A, wireless Mobile broadband service (WMBS), and the like and the communication unit transmits/receives data according to at least one wireless Internet technology in a range to include even Internet technologies which are not enumerated as above. Further, the short-range communication technology may include Bluetooth, radio frequency identification (RFID), infrared data association (IrDA), ultra-wideband (UWB), ZigBee, near field communication (NFC), ultra sound communication (USC), visible light communication (VLC), Wi-Fi, Wi-Fi direct, and the like. Further, the wired communication technique may include power line communication (PLC), USB communication, Ethernet, serial communication, optical/coaxial cable, or the like.

Further, the advertisement transmission service providing device 400 may transmit the information with any terminal through a universal serial bus (USB).

Further, the advertisement transmission service providing device 400 receives advertisement volume information, a plurality of advertisement information, unique IDs of the plurality of advertisement information, and the like which are transmitted from the advertisement scheduling service providing device 200. In this case, the unique ID (alternatively, the unique ID for each advertisement information) is information matched with the landing address.

Further, the advertisement transmission service providing device 400 stores the received advertisement volume information, the plurality of advertisement information, the unique IDs for the plurality of advertisement information, and the like (alternatively, performs an update function between the received information and exiting information).

Further, the advertisement transmission service providing device 400 receives the advertisement request signal transmitted from the user equipment 500, the identification information of the user equipment 500, and the like. Herein, the identification information of the user equipment 500 includes a mobile directory number (MDN), a mobile IP, a mobile MAC, subscriber identification module (Sim) card unique information, a serial number, and the like.

Further, the advertisement transmission service providing device 400 transmits, to the user equipment 500, at least one advertisement information of the plurality of prestored advertisement information, the unique ID corresponding to the advertisement information (alternatively, the unique ID of the advertisement information), and the like.

That is, the advertisement transmission service providing device 400 verifies at least one advertisement information based on predetermined advertising advertisement scheduling information (alternatively, predetermined reference/setting information) in the plurality of prestored advertisement information. Further, the advertisement transmission service providing device 400 verifies a unique ID corresponding to the verified at least one advertisement information. Further, the advertisement transmission service providing device 400 transmits the verified at least one advertisement information, the unique ID corresponding to the advertisement information, and the like to the user equipment 500.

As such, the advertisement transmission service providing device 400 manages the plurality of advertisement information, the unique IDs of the corresponding advertisement information, and the like which are provided from the advertisement scheduling service providing device 200.

Further, as such, when the advertisement information is requested from the user equipment 500, the advertisement transmission service providing device 400 provides at least one advertisement information to the corresponding user equipment 500 requesting the advertisement information according to the scheduling information from the corresponding advertisement scheduling service providing device 200 in the plurality of prestored advertisement information and simultaneously provides the unique ID related with the corresponding advertisement information to the corresponding user equipment 500.

The user equipment 500 may be applied to various terminals such as a smart phone, a portable terminal, a mobile terminal, a personal digital assistant (PDA), a portable multimedia player (PMP), a telematics terminal, a navigation terminal, a personal computer, a laptop computer, a slate PC, a tablet PC, an ultrabook, a wearable device (including, for example, a smartwatch, a smart glass, a head mounted display (HMD), and the like), a Wibro terminal, an internet protocol television (IPTV) terminal, a smart TV, a digital broadcasting terminal, a television, a 3D television, a home theater system, an audio video navigation (AVN) terminal, an audio/video (A/V) system, and a flexible terminal.

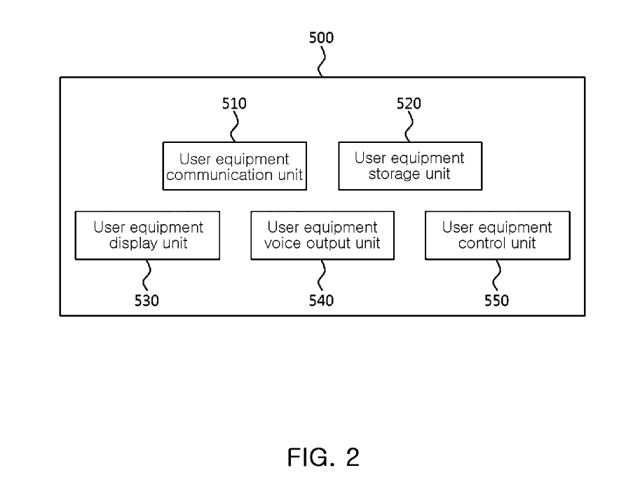

As illustrated in FIG. 2, the user equipment 500 is constituted by a user equipment communication unit 510, a user equipment storage unit 520, a user equipment display unit 530, a user equipment voice output unit 540, and a user equipment control unit 550. All the components of the user equipment 500 illustrated in FIG. 2 are not essential components, and the user equipment 500 may be implemented by more components than the components illustrated in FIG. 2 or less components therethan.

The user equipment communication unit 510 communicates with a predetermined internal component or at least one predetermined external terminal via a wired/wireless communication network. In this case, any external terminal may include the advertisement transmission service providing device 400, the log storing and landing service providing device 600, and the like. Herein, the wireless Internet technology includes WLAN, DLNA, Wibro, Wimax, HSDPA, HSUPA, IEEE 802.16, long term evolution (LTE), LTE-A, wireless Mobile broadband service (WMBS), and the like, and the user equipment communication unit 510 transmits/receives data according to at least one wireless Internet technology in a range to include even Internet technologies which are not enumerated above. Further, the short-range communication technology may include Bluetooth, radio frequency identification (RFID), infrared data association (IrDA), ultra-wideband (UWB), ZigBee, near field communication (NFC), ultra sound communication (USC), visible light communication (VLC), Wi-Fi, Wi-Fi direct, and the like. Further, the wired communication technique may include power line communication (PLC), USB communication, Ethernet, serial communication, optical/coaxial cable, or the like.

Further, the user equipment communication unit 510 may mutually transmit the information with any terminal through a universal serial bus (USB).

Further, the user equipment communication unit 510 transmits and receives a wireless signal to and from a base station, the advertisement transmission service providing device 400, the log storing and landing service providing device 600, and the like on a mobile communication network constructed according to technical standards or communication schemes for mobile communication (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the user equipment communication unit 510 transmits an advertisement information request signal, identification information of the user equipment 500, and the like to the advertisement transmission service providing device 400, by a control of the user equipment control unit 550. Herein, the identification information of the user equipment 500 includes an MDN, a mobile IP, a mobile MAC, subscriber identification module (Sim) card unique information, a serial number, and the like.

The user equipment storage unit 520 stores various user interfaces (UIs), graphic user interfaces (GUIs), and the like.

Further, the user equipment storage unit 520 stores data, programs, and the like which are required to operate the user equipment 500.

That is, the user equipment storage unit 520 may store a plurality of application programs (alternatively, applications) driven in the user equipment 500 and data and commends for the operation of the user equipment 500. At least some of the application programs may be downloaded from an external service providing device through wireless communication. Further, at least some of the application programs may be present on the user equipment 500 from a release time for basic functions (for example, phone receipt and call functions and message receiving and sending functions) of the user equipment 500. Meanwhile, the application programs are stored in the user equipment storage unit 520 and installed on the user equipment 500 to be driven to perform an operation (alternatively, a function) of the user equipment 500 by the user equipment control unit 550.

Further, the user equipment storage unit 520 may include at least one storage medium of a flash memory type, a hard disk type, a multimedia card micro type, a card type memory (for example, an SD or XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user equipment 500 may operate a web storage performing a storage function of the user equipment storage unit 520 on the Internet or operate in association with the web storage.

Further, the user equipment storage unit 520 stores at least one advertisement information, the unique ID corresponding to the advertisement information, and the like which are transmitted from the advertisement transmission service providing device 400 by the control of the user equipment control unit 550.

The user equipment display unit 530 may display various contents such as various menu screens by using the user interface and/or the graphic user interface which is stored in the user equipment storage unit 520 by the control of the user equipment control unit 550. Herein, the contents displayed on the user equipment display unit 530 include a menu screen including various texts or image data (including various information data) and data such as icons, a list menu, and a combo box, and the like. Further, the user equipment display unit 530 may be a touch screen.

Moreover, the user equipment display unit 530 may include at least one of a liquid crystal display (LCD), a thin film transistor-liquid crystal display (TFT LCD), an organic light-emitting diode (OLED), a flexible display, a 3D display, an electronic ink (e-ink) display, and a light emitting diode (LED).

Further, the user equipment display unit 530 may be constituted as a stereoscopic display unit displaying a stereoscopic image.

A 3D display type such as a stereoscopic type (a glasses type), an auto-stereoscopic type (a glassless type), and a projection type (a holographic type) may be applied to the stereoscopic display unit.

Further, the user equipment display unit 530 displays at least one advertisement information, the unique ID corresponding to the advertisement information, and the like, which are transmitted from the advertisement transmission service providing device 400 by the control of the user equipment control unit 550.

The user equipment voice output unit 540 outputs voice information included in a processed predetermined signal by the user equipment control unit 550. Herein, the user equipment voice output unit 540 may include a receiver, a speaker, a buzzer, and the like.

Further, the user equipment voice output unit 540 outputs a guidance voice generated by the user equipment control unit 550.

Further, the user equipment voice output unit 540 outputs voice information corresponding to at least one advertisement information, the unique ID corresponding to the advertisement information, and the like, which are transmitted from the advertisement transmission service providing device 400 by the control of the user equipment control unit 550.

The user equipment control unit 550 executes an overall control function of the user equipment 500.

Further, the user equipment control unit 550 executes the overall control function of the user equipment 500 by using the programs and data stored in the user equipment storage unit 520. The user equipment control unit 550 may include a RAM, a ROM, a CPU, a GPU, and a bus, and the RAM, the ROM, the CPU, the GPU, and the like may be connected to each other through the bus. The CPU accesses the user equipment storage unit 520 to perform booting by using an O/S stored in the user equipment storage unit 520 and may perform various operations by using various programs, contents, data, and the like stored in the user equipment storage unit 520.

Further, the user equipment control unit 550 generates an advertisement request signal for requesting the advertisement.

Further, the user equipment control unit 550 transmits the generated advertisement request signal, the identification information of the user equipment 500, and the like to the advertisement transmission service providing device 400 through the user equipment communication unit 510.

Further, the user equipment control unit 550 receives, through the user equipment communication unit 510, at least one advertisement information, the unique ID corresponding to the corresponding advertisement information (alternatively, the unique ID of the advertisement information), and the like which are transmitted from the advertisement transmission service providing device 400 in response to the above transmitted advertisement request signal.

Further, the user equipment control unit 550 outputs the received at least one advertisement information, the unique ID corresponding to the corresponding advertisement information, and the like through the user equipment display unit 530 and/or the user equipment voice output unit 540.

Further, when a unique ID of specific advertisement information is selected from the unique IDs of at least one advertisement information displayed on the user equipment display unit 530, the user equipment control unit 550 transmits the selected unique ID of the specific advertisement information, identification information of the user equipment 500, and the like to the log storing and landing service providing device 600 through the user equipment communication unit 510.

Further, the user equipment control unit 550 accesses a landing page corresponding to the corresponding unique ID of the specific advertisement information by interlocking with the log storing and landing service providing device 600.

Further, the user equipment control unit 550 outputs information provided from the accessed landing page (alternatively, advertisement information/advertisement information corresponding to the unique ID of the specific advertisement information) through the user equipment display unit 530 and/or the user equipment voice output unit 540.

Further, the user equipment 500 may further include an interface unit (not illustrated) serving as an interface with all external devices connected to the corresponding user equipment 500. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Herein, the identification module is a chip for storing various kinds of information for authenticating a use authority of the user equipment 500 and may include a user identity module (UIM), a subscriber identity module (SIM), a universal subscriber identity module (USIM), and the like. Further, the device provided with the identification module may be prepared in a smart card form. Accordingly, the identification module may be connected with the user equipment 500 through the port. Such an interface unit receives data or power from an external device to transmit the received data or power to each component in the user equipment 500 or transmit the data in the user equipment 500 to the external device.

Further, the interface unit may be a passage through which the power from a cradle is supplied to the corresponding user equipment 500 when the user equipment 500 is connected with an external cradle or a passage through which various command signals input from the cradle by the user are transferred to the corresponding user equipment 500. Various command signals input from the cradle or the corresponding power may also operate by a signal for recognizing that the user equipment 500 is accurately installed on the cradle.

Further, the user equipment 500 may further include an input unit (not illustrated) for receiving a signal according to a button operation of the user or any function selection or receiving a command or a control signal generated by an operation such as touching/scrolling the displayed screen.

The input unit as a means for receiving at least one of a user's command, selection, data, and information may include a plurality of input keys and function keys for receiving figure or text information and setting various functions.

Further, the input unit may adopt various devices such as a key pad, a dome switch, a touch pad (static pressure/electrostatic), a touch screen, a jog wheel, a jog switch, a jog shuttle, a mouse, a stylus pen, and a touch pen. Particularly, when the user equipment display unit 530 is formed in a touch screen form, some or all of the input functions may be performed by the user equipment display unit 530.

Further, each component (alternatively, each module) of the user equipment 500 may be software stored on a memory (alternatively, the user equipment storage unit 520) of the user equipment 500. The memory may be an internal memory of the user equipment 500 and may an external memory or other types of storage devices. Further, the memory may be a non-volatile memory. The software stored on the memory may include a command set to allow the user equipment 500 to perform a specific operation while executing.

The log storing and landing service providing device 600 communicates with any internal component or any of at least one external terminal via a wired/wireless communication network. In this case, any external terminal may include the user equipment 500, the landing address cache database 300, and the like. Herein, the wireless Internet technology includes WLAN, DLNA, Wibro, Wimax, HSDPA, HSUPA, IEEE 802.16, long term evolution (LTE), LTE-A, wireless Mobile broadband service (WMBS), and the like and the data are transmitted/received according to at least one wireless Internet technology in a range to include even Internet technologies which are not enumerated above. Further, the short-range communication technology may include Bluetooth, radio frequency identification (RFID), infrared data association (IrDA), ultra-wideband (UWB), ZigBee, near field communication (NFC), ultra sound communication (USC), visible light communication (VLC), Wi-Fi, Wi-Fi direct, and the like. Further, the wired communication technique may include power line communication (PLC), USB communication, Ethernet, serial communication, optical/coaxial cable, or the like.

Further, the log storing and landing service providing device 600 may transmit the information with any terminal through a universal serial bus (USB).

Further, the log storing and landing service providing device 600 receives the unique ID of the specific advertisement information transmitted from the user equipment 500, the identification information of the user equipment 500, and the like.

Further, the log storing and landing service providing device 600 accesses the landing address cache database 300 to verify (alternatively, retrieve) the landing address corresponding to the unique ID of the corresponding specific advertisement information among landing addresses for the plurality of unique IDs (alternatively, a landing address for each unique ID of the advertisement information) which are prestored in the landing address cache database 300.

As a result, when the landing address corresponding to the unique ID of the corresponding specific advertisement information is not verified in the landing addresses for the plurality of unique IDs which are prestored in the corresponding landing address cache database 300 (alternatively, the landing address for each unique ID of the advertisement information), the log storing and landing service providing device 600 provides information representing that the landing address corresponding to the unique ID of the corresponding specific advertisement information is not retrieved, to the user equipment 500. Further, the corresponding user equipment 500 receives the information representing that the landing address corresponding to the unique ID of the corresponding specific advertisement information which is transmitted from the log storing and landing service providing device 600 is not retrieved and displays information representing that the received landing address corresponding to the unique ID of the corresponding specific advertisement information is not retrieved.

As such, when the landing address corresponding to the unique ID of the corresponding specific advertisement information is not verified in the landing addresses for the plurality of unique IDs which are prestored in the corresponding landing address cache database 300 (alternatively, the landing address for each unique ID of the advertisement information), the log storing and landing service providing device 600 determines that the unique ID of the corresponding specific advertisement information is modified by hacking and the like to discard (alternatively, delete) the unique ID of the corresponding specific advertisement information without redirecting the corresponding user equipment 500 to the landing address corresponding to the unique ID of the corresponding specific advertisement information.

Further, the log storing and landing service providing device 600 redirects the corresponding user equipment 500 to the verified landing address to access the user equipment 500 to the advertiser service providing device corresponding to the corresponding landing address.

As such, instead of directly exposing the landing address to in the user equipment 500, the unique ID related with the landing address is provided to the user equipment 500 and the log storing and landing service providing device 600 may redirect the user equipment 500 to the landing address corresponding to the corresponding unique ID through the unique ID provided to the user equipment 500.

Further, the landing address does not heavily move between communication protocols to ensure stability.

Further, even though the corresponding unique ID (alternatively, the unique ID of the advertisement information) is modified by hacking, when the log storing and landing service providing device 600 verifies the landing address cache database 300 based on the corresponding modified unique ID, if the corresponding modified unique ID is not present, the landing address cannot be found to be protected from hacking. In addition, even though the landing address corresponding to the corresponding modified unique ID is present, only incorrect landing is performed to prevent a possibility to be infected with malicious codes in the user equipment 500 as an advertisement receiver.

In the embodiment of the present invention, it is described that the landing address cache database 300 is separated from the advertisement database 100 included in the advertising system 10, but the present invention is not limited thereto. The advertisement database 100 and the landing address cache database 300 may be integrated to a single database (not illustrated) to be operated and managed.

Further, in the embodiment of the present invention, it is described that the advertisement scheduling service providing device 200, the advertisement transmission service providing device 400, and the log storing and landing service providing device 600 are separated from each other, but the present invention is not limited thereto. The advertisement scheduling service providing device 200, the advertisement transmission service providing device 400, and the log storing and landing service providing device 600 may be integrated to a single service providing device (alternatively, a single server) (not illustrated) to be operated and managed.

As such, instead of directly transmitting the landing address to the user equipment requesting the advertisement together with the advertisement information, the advertisement information and the unique ID of the advertisement information corresponding to the landing address may be provided to the user equipment.

Further, as such, when the unique ID of the advertisement information is selected, the corresponding user equipment transmits the selected unique ID of the advertisement information to the log storing and landing service providing device, and the corresponding log storing and landing service providing device may redirect the corresponding terminal to the landing address corresponding to the unique ID of the advertisement information.

Hereinafter, a control method of an advertising system controlling access to a landing page according to the present invention will be described in detail with reference to FIGS. 1 to 8.

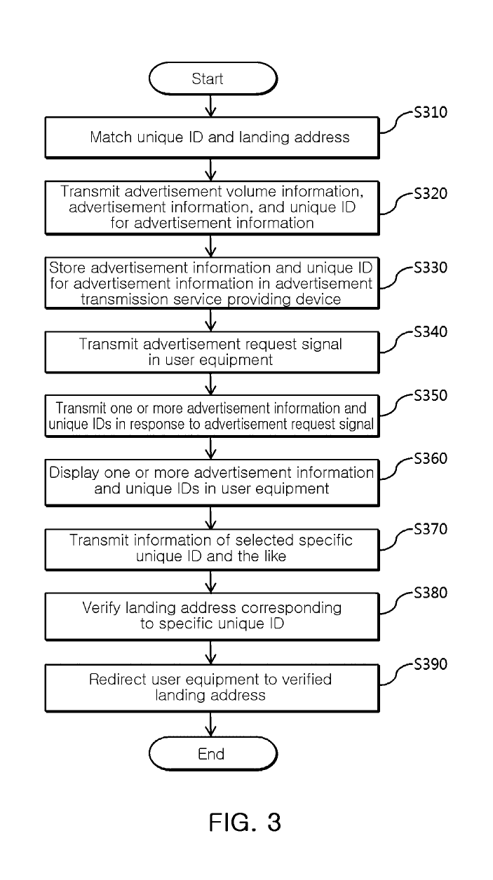

FIG. 3 is a flowchart illustrating a control method of an advertising system which controls access to a landing page according to a first embodiment of the present invention.

First, the advertisement scheduling service providing device 200 matches the landing address for the corresponding advertisement information with the unique ID (alternatively, a unique key value) of the advertisement information corresponding to the advertisement information, with respect to the plurality of advertisement information stored in the advertisement database 100. Herein, the corresponding advertisement information may be a multimedia content form, and includes information regarding at least one store related with the advertiser, at least one product, and the like.

Further, the advertisement scheduling service providing device 200 stores the matched information (alternatively, a landing address for each unique ID of the matched advertisement information/a landing address for each matched unique ID) in the landing address cache database 300.

In this case, the advertisement scheduling service providing device 200 may also perform a scheduling function for the plurality of advertisement information stored in the advertisement database 100.

As an example, with respect to first advertisement information, second advertisement information, and third advertisement information stored in the advertisement database 100, the advertisement scheduling service providing device 200 matches a first landing address for the corresponding first advertisement information with a first unique ID corresponding to the first advertisement information, matches a second landing address for the corresponding second advertisement information with a second unique ID corresponding to the second advertisement information, matches a third landing address for the corresponding third advertisement information with a third unique ID corresponding to the third advertisement information, matches a fourth landing address for the corresponding fourth advertisement information with a fourth unique ID corresponding to the fourth advertisement information, and matches a fifth landing address for the corresponding fifth advertisement information with a fifth unique ID corresponding to the fifth advertisement information.

Further, the advertisement scheduling service providing device 200 stores the matched information (for example, including the first unique ID and the first landing address of the first advertisement information, the second unique ID and the second landing address of the second advertisement information, the third unique ID and the third landing address of the third advertisement information, the fourth unique ID and the fourth landing address of the fourth advertisement information, and the fifth unique ID and the fifth landing address of the fifth advertisement information) in the landing address cache database 300 (S310).

Thereafter, the advertisement scheduling service providing device 200 transmits advertisement volume information, a plurality of advertisement information, unique IDs of the plurality of advertisement information, and the like to the advertisement transmission service providing device 400.

As an example, the advertisement scheduling service providing device 200 transmits advertisement volume information (for example, five), the first to fifth advertisement information, and unique IDs for the plurality of advertisement information (for example, including the first unique ID of the first advertisement information, the second unique ID of the second advertisement information, the third unique ID of the third advertisement information, the fourth unique ID of the fourth advertisement information, and the fifth unique ID of the fifth advertisement information), and the like to the advertisement transmission service providing device 400 (S320).

Thereafter, the advertisement transmission service providing device 400 receives the advertisement volume information, the plurality of advertisement information, the unique IDs of the plurality of advertisement information, and the like, which are transmitted from the advertisement scheduling service providing device 200.

Further, the advertisement transmission service providing device 400 stores the received advertisement volume information, the plurality of advertisement information, the unique IDs for the plurality of advertisement information, and the like (alternatively, performs an update function between the received information and exiting information).

As an example, the advertisement transmission service providing device 400 stores the advertisement volume information (for example, five), the first to fifth advertisement information, and the unique IDs for the plurality of advertisement information (for example, including the first unique ID of the first advertisement information, the second unique ID of the second advertisement information, the third unique ID of the third advertisement information, the fourth unique ID of the fourth advertisement information, and the fifth unique ID of the fifth advertisement information), and the like, which are transmitted from the advertisement scheduling service providing device 200 (S330).

Thereafter, the user equipment 500 transmits an advertisement request signal for requesting the advertisement, identification information of the user equipment 500, and the like, to the advertisement transmission service providing device 400. Herein, the identification information of the user equipment 500 includes an MDN, a mobile IP, a mobile MAC, subscriber identification module (Sim) card unique information, a serial number, and the like.

As an example, the user equipment 500 generates an advertisement request signal for requesting the advertisement information, and transmits the generated advertisement request signal, identification information of the user equipment 500, and the like, to the advertisement transmission service providing device 400 (S340).

Thereafter, the advertisement transmission service providing device 400 receives the advertisement request signal transmitted from the user equipment 500, the identification information of the user equipment 500, and the like.

Further, the advertisement transmission service providing device 400 transmits, to the user equipment 500, at least one advertisement information of the plurality of prestored advertisement information, the unique ID corresponding to the advertisement information (alternatively, the unique ID of the advertisement information), and the like.

That is, the advertisement transmission service providing device 400 verifies at least one advertisement information based on predetermined advertisement scheduling information (alternatively, predetermined reference/setting information) in the plurality of prestored advertisement information. Further, the advertisement transmission service providing device 400 verifies a unique ID corresponding to the verified at least one advertisement information. Further, the advertisement transmission service providing device 400 transmits the verified at least one advertisement information, the unique ID corresponding to the advertisement information, and the like to the user equipment 500.

As an example, the advertisement transmission service providing device 400 transmits the first advertisement information, the third advertisement information, and the fourth advertisement information among the plurality of prestored advertisement information, and the first unique ID corresponding to the first advertisement information, the third unique ID corresponding to the third advertisement information, and the fourth unique ID corresponding to the fourth advertisement information, and the like to the user equipment 500 (S350).

Thereafter, the user equipment 500 receives at least one advertisement information, the unique ID corresponding to the corresponding advertisement information (alternatively, the unique ID of the advertisement information), and the like which are transmitted from the advertisement transmission service providing device 400 in response to the above transmitted advertisement request signal.

Further, the user equipment 500 displays the received at least one advertisement information, the unique ID corresponding to the corresponding advertisement information, and the like.

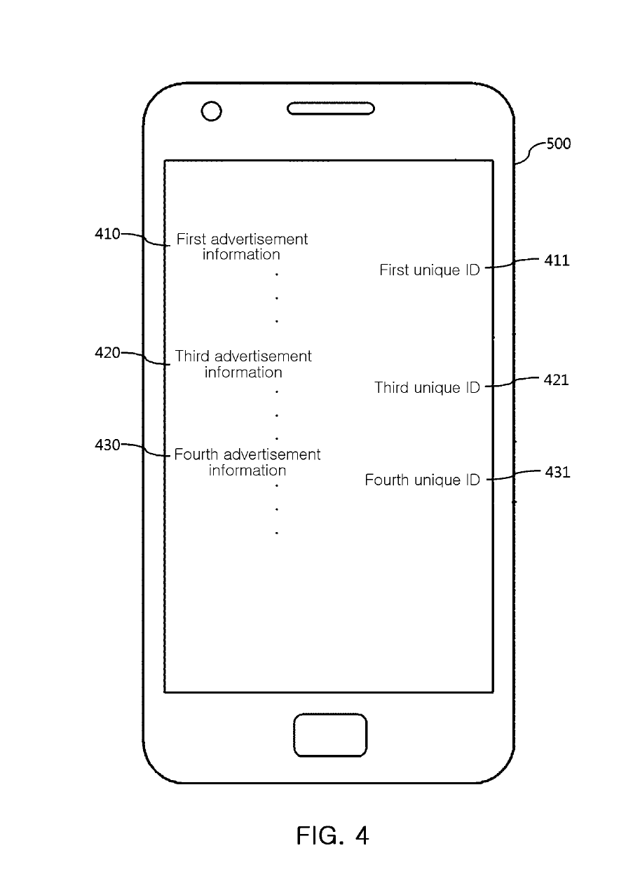

As an example, as illustrated in FIG. 4, the user equipment 500 displays first advertisement information 410, third advertisement information 420, fourth advertisement information 430, a first unique ID 411 corresponding to the first advertisement information, a third unique ID 421 corresponding to the third advertisement information, and a fourth unique ID 431 corresponding to the fourth advertisement information, and the like which are transmitted from the advertisement transmission service providing device 400 (S360).

Thereafter, when a unique ID of specific advertisement information is selected from unique IDs of at least one advertisement information displayed on the user equipment 500, the user equipment 500 transmits the selected unique ID of the specific advertisement information, identification information of the user equipment, and the like to the log storing and landing service providing device 600.

As an example, when the third unique ID 421 is selected from the first advertisement information 410, the third advertisement information 420, the fourth advertisement information 430, the first unique ID 411 corresponding to the first advertisement information, the third unique ID 421 corresponding to the third advertisement information, and the fourth unique ID 431 corresponding to the fourth advertisement information which are illustrated in FIG. 4, the user equipment 500 transmits the selected third unique ID of the corresponding third advertisement information, the identification information of the user equipment 500, and the like to the log storing and landing service providing device 600 (S370).

Thereafter, the log storing and landing service providing device 600 receives the unique ID of the specific advertisement information transmitted from the user equipment 500, the identification information of the user equipment 500, and the like.

Further, the log storing and landing service providing device 600 accesses the landing address cache database 300 to verify (alternatively, retrieve) the landing address corresponding to the unique ID of the corresponding specific advertisement information among landing addresses for the plurality of unique IDs (alternatively, a landing address for each unique ID of the advertisement information) which are prestored in the landing address cache database 300.

As an example, the log storing and landing service providing device 600 verifies a landing address (for example, http://www.abcd.com) corresponding to the third unique ID transmitted from the user equipment 500 among the landing addresses for the plurality of unique IDs which are prestored in the landing address cache database 300 (S380).

Thereafter, the log storing and landing service providing device 600 redirects the corresponding user equipment 500 to the verified landing address to access the user equipment 500 to the advertiser service providing device corresponding to the corresponding landing address.

As an example, the log storing and landing service providing device 600 redirects the user equipment 500 to the verified landing address (for example, http://www.abcd.com) (S390).

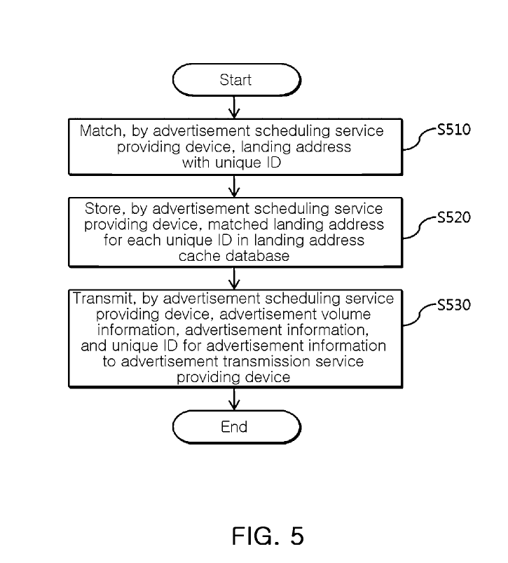

FIG. 5 is a flowchart illustrating a control method of an advertisement scheduling service providing device according to a second embodiment of the present invention.

First, the advertisement scheduling service providing device 200 matches the landing address for the corresponding advertisement information with the unique ID (alternatively, a unique key value) of the advertisement information corresponding to the advertisement information, with respect to the plurality of advertisement information stored in the advertisement database 100. Herein, the corresponding advertisement information may be a multimedia content form, and includes information regarding at least one store related with the advertiser, at least one product, and the like.

In this case, the advertisement scheduling service providing device 200 may also perform a scheduling function for the plurality of advertisement information stored in the advertisement database 100.

As an example, with the first advertisement information, the second advertisement information, and the third advertisement information which are stored in the advertisement database 100, the advertisement scheduling service providing device 200 matches a first landing address for the corresponding first advertisement information with the first unique ID corresponding to the first advertisement information, matches a second landing address for the corresponding second advertisement information with the second unique ID corresponding to the second advertisement information, and matches a third landing address for the corresponding third advertisement information with the third unique ID corresponding to the third advertisement information (S510).

Thereafter, the advertisement scheduling service providing device 200 stores the matched information (alternatively, a landing address for each unique ID of the matched advertisement information/a landing address for each matched unique ID) in the landing address cache database 300.

As an example, the advertisement scheduling service providing device 200 stores the matched information (for example, including the first unique ID and the first landing address of the first advertisement information, the second unique ID and the second landing address of the second advertisement information, the third unique ID and the third landing address of the third advertisement information, and the like) in the landing address cache database 300 (S520).

Thereafter, the advertisement scheduling service providing device 200 transmits advertisement volume information, a plurality of advertisement information, unique IDs of the plurality of advertisement information, and the like to the advertisement transmission service providing device 400.

As an example, the advertisement scheduling service providing device 200 transmits advertisement volume information (for example, three), the first to third advertisement information, and unique IDs for the plurality of advertisement information (for example, including the first unique ID of the first advertisement information, the second unique ID of the second advertisement information, the third unique ID of the third advertisement information, and the like), and the like to the advertisement transmission service providing device 400 (S530).

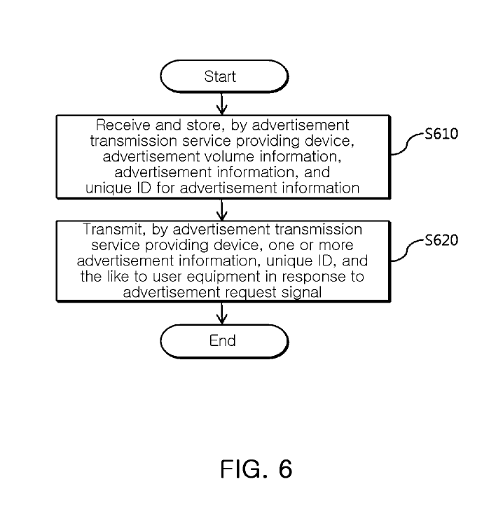

FIG. 6 is a flowchart illustrating a control method of an advertisement transmission service providing device according to a third embodiment of the present invention.

First, the advertisement transmission service providing device 400 receives advertisement volume information, a plurality of advertisement information, unique IDs of the plurality of advertisement information, and the like which are transmitted from the advertisement scheduling service providing device 200. Herein, the corresponding advertisement information may be a multimedia content form, and includes information regarding at least one store related with the advertiser, at least one product, and the like. In this case, the unique ID for each advertisement information (alternatively, the unique ID) is information matched with the landing address.

Further, the advertisement transmission service providing device 400 stores the received advertisement volume information, the plurality of advertisement information, the unique IDs for the plurality of advertisement information, and the like (alternatively, performs an update function between the received information and exiting information).

As an example, the advertisement transmission service providing device 400 stores the advertisement volume information (for example, three), the first to third advertisement information, and the unique IDs for the plurality of advertisement information (for example, including the first unique ID of the first advertisement information, the second unique ID of the second advertisement information, the third unique ID of the third advertisement information, and the like), and the like, which are transmitted from the advertisement scheduling service providing device 200 (S610).

Thereafter, the advertisement transmission service providing device 400 receives the advertisement request signal transmitted from the user equipment 500, the identification information of the user equipment 500, and the like.

Further, the advertisement transmission service providing device 400 transmits at least one advertisement information of the plurality of prestored advertisement information, the unique ID corresponding to the advertisement information (alternatively, the unique ID of the advertisement information), and the like.

That is, the advertisement transmission service providing device 400 verifies at least one advertisement information based on predetermined advertisement scheduling information (alternatively, predetermined reference/setting information) in the plurality of prestored advertisement information. Further, the advertisement transmission service providing device 400 verifies a unique ID corresponding to the verified at least one advertisement information. Further, the advertisement transmission service providing device 400 transmits the verified at least one advertisement information, the unique ID corresponding to the advertisement information, and the like to the user equipment 500.

As an example, the advertisement transmission service providing device 400 transmits the first advertisement information and the second advertisement information among the plurality of prestored advertisement information, and the first unique ID corresponding to the first advertisement information, the second unique ID corresponding to the second advertisement information, and the like to the user equipment 500 (S620).

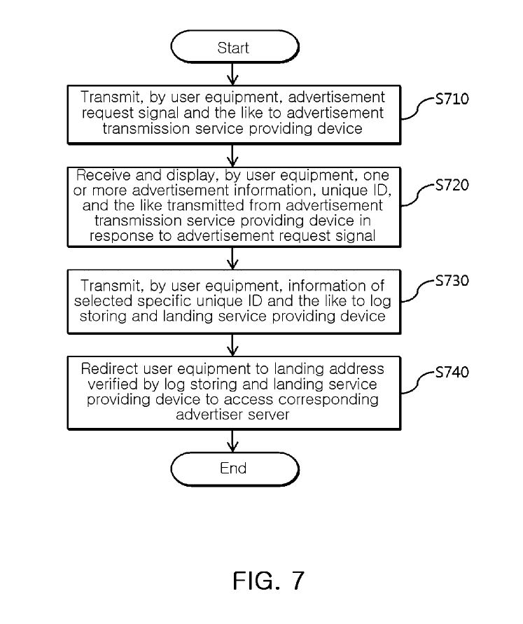

FIG. 7 is a flowchart illustrating a control method of user equipment according to a fourth embodiment of the present invention.

First, the user equipment 500 transmits an advertisement request signal for requesting the advertisement, identification information of the user equipment 500, and the like, to the advertisement transmission service providing device 400. Herein, the identification information of the user equipment 500 includes an MDN, a mobile IP, a mobile MAC, subscriber identification module (Sim) card unique information, a serial number, and the like.

As an example, the user equipment 500 generates an advertisement request signal for requesting the advertisement information, and transmits the generated advertisement request signal, identification information of the user equipment 500, and the like, to the advertisement transmission service providing device 400 (S710).

Thereafter, the user equipment 500 receives at least one advertisement information, the unique ID corresponding to the corresponding advertisement information (alternatively, the unique ID of the advertisement information), and the like which are transmitted from the advertisement transmission service providing device 400 in response to the transmitted advertisement request signal.

Further, the user equipment 500 displays the received at least one advertisement information, the unique ID corresponding to the corresponding advertisement information, and the like.

As an example, the user equipment 500 displays the first advertisement information, the second advertisement information, the first unique ID corresponding to the first advertisement information, the second unique ID corresponding to the second advertisement information, and the like which are transmitted from the advertisement transmission service providing device 400 (S720).

Thereafter, when a unique ID of specific advertisement information is selected from unique IDs of at least one advertisement information displayed on the user equipment 500, the user equipment 500 transmits the selected unique ID of the specific advertisement information, identification information of the user equipment, and the like to the log storing and landing service providing device 600.

As an example, when the second unique ID is selected from the first advertisement information, the second advertisement information, the first unique ID corresponding to the first advertisement information, the second unique ID corresponding to the second advertisement information which are displayed on the user equipment 500, the user equipment 500 transmits the selected second unique ID of the corresponding second advertisement information, the identification information of the user equipment 500, and the like to the log storing and landing service providing device 600 (S730).

Thereafter, the user equipment 500 is redirected to the verified landing address by the control of the log storing and landing service providing device 600 based on the transmitted unique ID of the corresponding specific advertisement information to access the advertiser service providing device (not illustrated) corresponding to the corresponding landing address.

Further, the user equipment 500 displays and stores the information (alternatively, the advertisement information/the advertisement information corresponding to the unique ID of the specific advertisement information) provided from the corresponding advertiser service providing device.

As an example, the user equipment 500 is redirected to the verified landing address (for example, http://www.abcd.com) by the control of the log storing and landing service providing device 600 based on the transmitted unique ID of the corresponding specific advertisement information (S740).

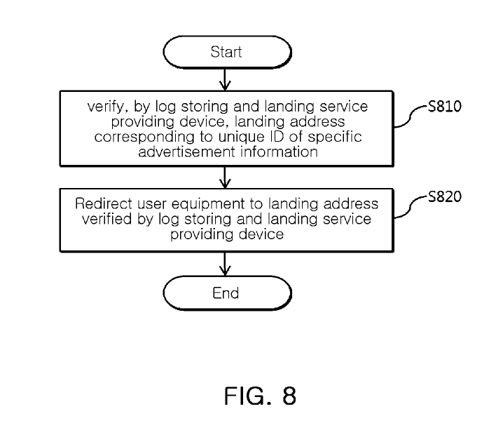

FIG. 8 is a flowchart illustrating a control method of a log storing and landing service providing device according to a fifth embodiment of the present invention.

First, the log storing and landing service providing device 600 receives the unique ID of the specific advertisement information, the identification information of the user equipment 500, and the like, which are transmitted from the user equipment 500. Herein, the identification information of the user equipment 500 includes an MDN, a mobile IP, a mobile MAC, subscriber identification module (Sim) card unique information, a serial number, and the like.

Further, the log storing and landing service providing device 600 accesses the landing address cache database 300 to verify (alternatively, retrieve) the landing address corresponding to the unique ID of the corresponding specific advertisement information among landing addresses for the plurality of unique IDs (alternatively, a landing address for each unique ID of the advertisement information), which are prestored in the landing address cache database 300.

For example, the log storing and landing service providing device 600 verifies a landing address (for example, http://www.abcd.com) corresponding to the second unique ID transmitted from the user equipment 500 among the landing addresses for the plurality of unique IDs which are prestored in the landing address cache database 300 (S810).

Thereafter, the log storing and landing service providing device 600 redirects the corresponding user equipment 500 to the verified landing address to access the user equipment 500 to the advertiser service providing device corresponding to the corresponding landing address.

As an example, the log storing and landing service providing device 600 redirects the user equipment 500 to the verified landing address (for example, http://www.abcd.com) (S820).

Further, when defining the term, the adhoc means a network without an infrastructure which is autonomously configured by nodes. For configuration and maintenance of the network, an infrastructure network device such as a base station and an access point is not required. The adhoc nodes communicates with each other by using a wireless interface, overcomes the constraints on a communication distance of a wireless interface by a multi-hop routing function, and a network topology is dynamically changed because the movement of the nodes is free. The adhoc network may be a completely independent type and interlock with an infrastructure network such as internet through an internet gateway. As application fields, emergency, urgent meetings, military networks in the battlefield, and the like are included. When the adhoc network is used, it is advantageous in fast network configuration and low cost. Further, device-to-device communication is possible anytime and anywhere without assistance of a central system.

When describing features of the adhoc network, in terms of security, basically, security requirements of the adhoc network are the same as requirements of other communication networks, and the network topology is dynamically changed because the movement is free. A temporal network configures a communication network when respective advertising platforms 100 (nodes) are close to each other, and the network may be temporarily configured without any central control or assistance of a standard support service. The information of the adhoc network is transmitted by a one-to-one multihop routing method, and in a mesh network, each advertising platform 100 may transmit and receive a message and serve as a router. Further, even though one connection is lost, the network may automatically transmit the message with another connection, and as the respective advertising platforms 100 are closer to each other, the intensity of the signal is increased. For example, if the distance is decreased in half, the signal may be increased four times. In addition, simply, the advertising platforms 100 may be added and removed.

Meta data is structured data for the data and means information that a machine may be understood with respect web data or other things, the meta data for one document may be present in the document and present to be separated from the document. The meta data for the document is a structured data for helping in searching and processing the document and the images by the user and the purpose is to maintain compatibility of the data, define a series of data elements required for the technology of network resources, and rapidly search the resources. The meta data have uniqueness, scalability, independence of phrases, selectivity, repeatability, and modifiability.

The uniqueness means an intrinsic property of the resource as a technical element, the scalability means using additional contents or properties other than defined required data elements as the technical element, the independence of phrases means not defining application fields or expression techniques, and the selectivity does not force whether respective elements are included. The repeatability means that all technical elements are repeatable, and the modifiability means that details are adjusted by using a modifier.

The routing means a path selection process of systematically determining a method of transferring a message (a packet and the like) up to the destination by using the address on the network, and a device of actively performing this process is called a router.

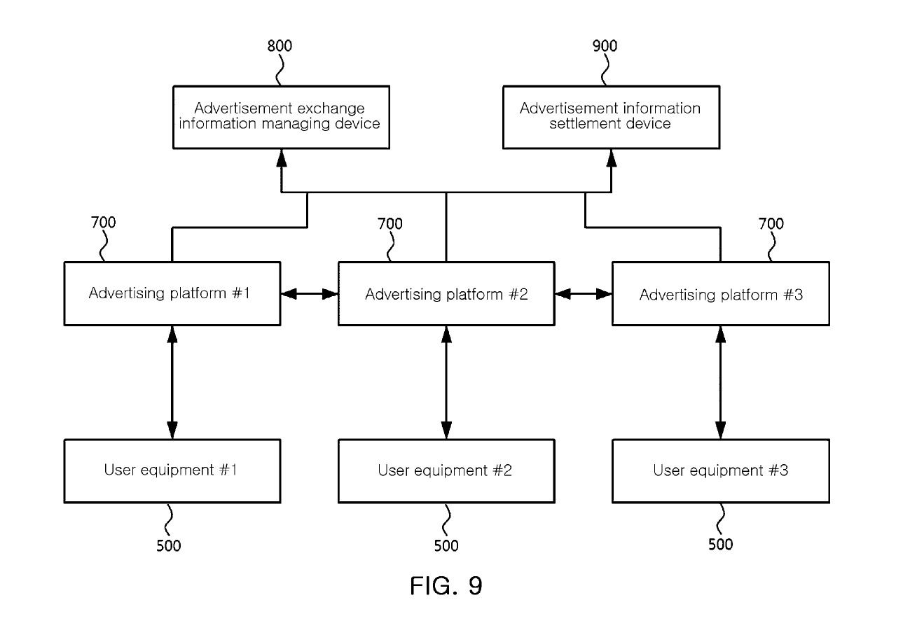

FIG. 9 is a block diagram illustrating a configuration an advertising system 20 which provides an advertisement exchange service between advertising platforms 700 according to an embodiment of the present invention.

As illustrated in FIG. 9, an advertising system 20 (alternatively, an advertisement exchanging system) is constituted by user equipment 500, an advertising platform 700, an advertisement exchange information managing device 800, and an advertisement information settlement device 900. All the components of the advertising system 20 illustrated in FIG. 9 are not required components, and the advertising system 20 may be implemented by more components than the components illustrated in FIG. 9 or less components therethan.

The advertising system 20 (alternatively, the advertisement exchanging system) includes user equipment requesting an advertisement to the advertising platform 700 when the application is executed, an advertising platform 700 which arranges router information for another adjacent advertising platform 700 according to a predetermined priority to register the arranged router information in a routing table, receives an advertisement request signal from the advertising platform 700, verifies whether the advertisement to be provided is present according to the advertisement request information to provide the advertisement to the user equipment, and transfers the advertisement request information to another advertising platform 700 when there is no advertisement to be provided, an advertisement exchange information managing device 800 which receives a record for the advertisement request information from at least one advertising platform 700, receives advertisement meta information from the advertising platform 700 having an advertisement to be provided, transfers the advertisement meta information to the advertising platform 700 requesting an initial advertisement, and transmits advertisement transfer information to the advertisement information settlement device 900, and an advertisement information settlement device 900 which receives the advertisement transfer information exposed in the user equipment from the advertisement exchange information managing device 800 and settles an advertisement fee by using the advertisement transfer information and an settlement API between the advertising platforms 700.

The user equipment 500 requests the advertisement to the advertising platform 700 when the application is executed.

The advertising platform 700 arranges router information for another adjacent advertising platform 700 according to a predetermined priority to register the arranged router information in a routing table, receives an advertisement request signal from the advertising platform 700, verifies whether the advertisement to be provided is present according to the advertisement request information to provide the advertisement to the user equipment 500, and transfers the advertisement request information to another advertising platform 700 when there is no advertisement to be provided. In this case, the advertisement request information may include at least one of an advertisement request time, a unique code of the advertising platform 700, and user information.

The advertisement exchange information managing device 800 receives a record for the advertisement request information from at least one advertising platform 700, receives advertisement meta information from the advertising platform 700 that there is an advertisement to be provided, transfers the advertisement meta information to the advertising platform 700 requesting an initial advertisement, and transmits advertisement transfer information to the advertisement information settlement device 900.

The advertisement information settlement device 900 receives the advertisement transfer information exposed in the user equipment 500 from the advertisement exchange information managing device 800 and settles an advertisement fee by using the advertisement transfer information and a settlement API between the advertising platforms 700.

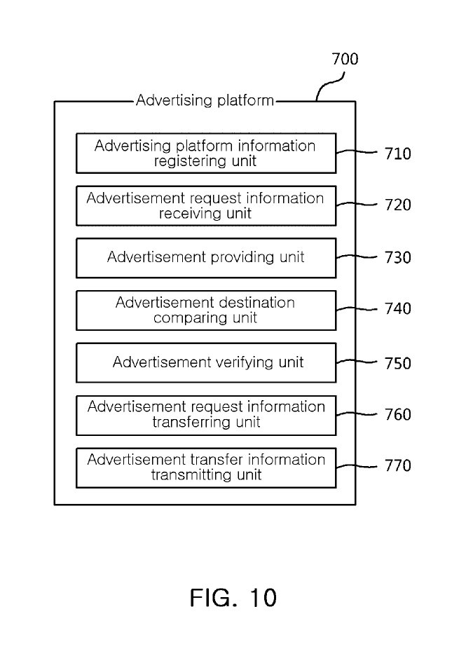

FIG. 10 is a block diagram illustrating a configuration of an advertising platform 700 according to an embodiment of the present invention.

As illustrated in FIG. 10, the advertising platform 700 is constituted by an advertising platform information registering unit 710, an advertisement request information receiving unit 720, and an advertisement providing unit 730. All of the components of the advertising platform 700 illustrated in FIG. 10 are not required components, and the advertising platform 700 may be implemented by more components than the components illustrated in FIG. 10 or less components therethan.

The advertising platform 700 includes the advertising platform information registering unit 710 which arranges router information for another adjacent advertising platform 700 according to a predetermined priority to register the arranged router information in a routing table, the advertisement request information receiving unit 720 which receives the advertisement request information from another advertising platform 700, and the advertisement providing unit 730 which provides the advertisement to the user equipment 500 according to the advertisement request information.

The advertising platform information registering unit 710 arranges router information for another adjacent advertising platform 700 according to a predetermined priority to register the arranged router information in a routing table.

In this case, the advertising platform information registering unit 710 may register the router information of another advertising platform 700 in the routing table when a size of the advertisement held by the advertising platform 700 requesting the advertisement coincides with a size of the advertisement held by another advertising platform 700.

Further, the advertising platform information registering unit 710 may register the router information of another advertising platform 700 in the routing table when an advertisement destination comparing unit 740 verifies that a transfer destination of the advertising platform 700 and a departure point of another advertising platform 700 are not the same as each other. However, the advertising platform information registering unit 710 may measure a network response time of other adjacent advertising platforms 700 every predetermined period and sequentially register the router information of other adjacent advertising platforms 700 in the routing table according to the response time.

That is, the registering means a process of notifying its own and peripheral information (routing update information and the like) at a predetermined period or if necessary between equipment in equipment such as a router and a wireless node. In this case, an updating period for the router information may be set by the user and routing protocols may update the updating period when the topology is changed. A method of updating the routing information may include partial updating or full updating, and all contents of the routing table are periodically updated by the full updating and only changed contents of the routing table are non-periodically updated by the partial updating when the network is changed.

Based on the routing update information, each router learns the router information of the adjacent advertising platform 700, an unreachable route is deleted, and the routing table may be synchronized by only reachable routes.

The advertising platform information registering unit 710 may be a device for storing the data and basically store data such as environmental parameters for search, classification, analysis, and the like.

The advertisement providing unit 730 provides the advertisement to the user equipment 500 according to the advertisement request information.

Meanwhile, the advertising platform 700 of the present invention may further include an advertisement destination comparing unit 740, an advertisement verifying unit 750, an advertisement request information transferring unit 760, and an advertisement transfer information transmitting unit 770.

The advertising platform 700 may include the advertisement destination comparing unit 740 which compares an advertisement transfer destination and a departure point between the advertising platforms 700, the advertisement verifying unit 750 which verifies whether the advertisement to be provided is present according to the advertisement request information received from the advertisement request information receiving unit 720, the advertisement request information transferring unit 760 which transfers the advertisement request information to another advertising platform 700, and the advertisement transfer information transmitting unit 770 which transmits the information transferred by the advertisement request information transferring unit 760 to the advertisement exchange information managing device 200.

The advertisement destination comparing unit 740 compares the advertisement transfer destination and the departure point between the advertising platforms 700.

The advertisement verifying unit 750 verifies whether the advertisement to be provided is present according to the advertisement request information received from the advertisement request information receiving unit 720.

The advertisement request information transferring unit 760 transfers the advertisement request information to another advertising platform 700. In this case, the advertisement request information transferring unit 760 may transfer the advertisement request information to another advertising platform 700 according to the routing table priority when the advertisement verifying unit 750 verifies that there is no advertisement to be provided, and provide the advertisement according to the advertisement request information when the advertisement verifying unit 750 verifies that there is the advertisement to be provided.

When the advertisement is provided, native advertising needs to be provided, and the advertisement providing unit 730 may provide the advertisement when a category value of the advertisement to be provided and a category value to which the user belongs coincide with each other, or provide the advertisement when a category value of the advertisement to be provided and a category value of a medium coincide with each other.

The advertisement transfer information transmitting unit 770 transmits the information transferred by the advertisement request information transferring unit 760 to the advertisement exchange information managing device 200.

In this case, the advertising platform 700 may be connected with another adjacent advertising platform 700 by an adhoc-network and the advertising platform 700 may provide the advertisement to the native application.

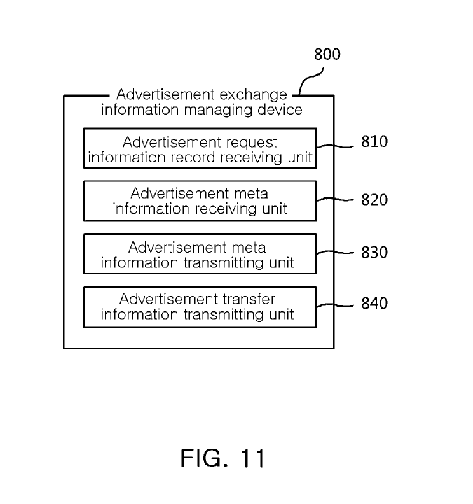

FIG. 11 is a block diagram illustrating a configuration of the advertisement exchange information managing device 800 according to the embodiment of the present invention.

As illustrated in FIG. 11, the advertisement exchange information managing device 800 is constituted by an advertisement request information record receiving unit 810, an advertisement meta information receiving unit 820, an advertisement meta information transmitting unit 830, and an advertisement transfer information transmitting unit 840. All the components of the advertisement exchange information managing device 800 illustrated in FIG. 11 are not required components, and the advertisement exchange information managing device 800 may be implemented by more components than the components illustrated in FIG. 11 or less components therethan.

The advertisement exchange information managing device 800 includes the advertisement request information record receiving unit 810 which receives a record for the advertisement request information from at least one advertising platform 700, the advertisement meta information receiving unit 820 which receives advertisement meta information from the advertising platform 700, the advertisement meta information transmitting unit 830 which transfers the advertisement meta information to the advertising platform 700 requesting an initial advertisement, and the advertisement transfer information transmitting unit 840 which transmits advertisement transfer information transferred by the advertisement meta information transmitting unit to the advertisement information settlement device 900.

The advertisement request information record receiving unit 810 receives a record for the advertisement request information from at least one advertising platform 700.

The advertisement meta information receiving unit 820 receives advertisement meta information from the advertising platform 700 having the advertisement to be provided.

The advertisement meta information transmitting unit 830 transfers the advertisement meta information to the advertising platform 700 requesting the initial advertisement.

The advertisement transfer information transmitting unit 840 transmits advertisement transfer information transferred by the advertisement meta information transmitting unit 830 to the advertisement information settlement device 900.

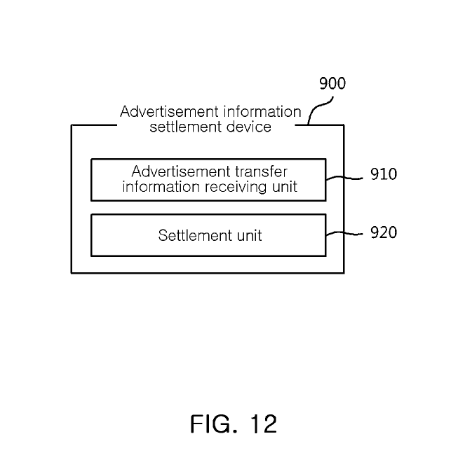

FIG. 12 is a block diagram illustrating a configuration of an advertisement information settlement device 900 according to an embodiment of the present invention.

As illustrated in FIG. 12, the advertisement information settlement device 900 is constituted by an advertisement transfer information receiving unit 910 and a settlement unit 920. All the components of the advertisement information settlement device 900 illustrated in FIG. 12 are not required components, and the advertisement information settlement device 900 may be implemented by more components than the components illustrated in FIG. 12 or less components therethan.

The advertisement information settlement device 900 includes the advertisement transfer information receiving unit 910 which receives the advertisement transfer information exposed in the user equipment 500 from the advertisement exchange information managing device 800 and the settlement unit 920 which settles an advertisement fee by using the advertisement transfer information exposed in the user equipment 500 received by the advertisement transfer information receiving unit 910 and the settlement API between the advertising platforms 700.

The advertisement transfer information receiving unit 910 receives the advertisement transfer information exposed in the user equipment 500 from the advertisement exchange information managing device 800.

The settlement unit 920 settles an advertisement fee by using the advertisement transfer information exposed in the user equipment 500 received by the advertisement transfer information receiving unit 910 and the settlement API between the advertising platforms 700.

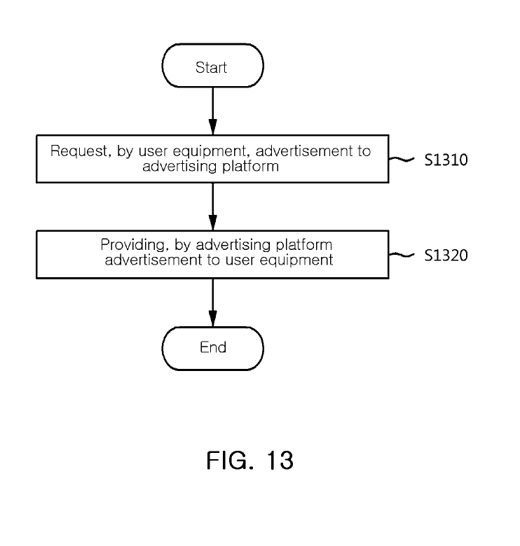

FIG. 13 is a flowchart illustrating an advertisement providing method of an advertising platform according to a request of user equipment according to an embodiment of the present invention.

A method of receiving an advertisement providing service from the advertising platform 100 in the user equipment 500 of the present invention includes (1) requesting the advertisement and (2) providing the advertisement.

That is, the method of receiving an advertisement providing service from the advertising platform 100 in the user equipment 500 includes requesting the advertisement to the advertising platform 700 by the user equipment 500 (S1310), and providing the advertisement to the user equipment 500 by the advertising platform 700.

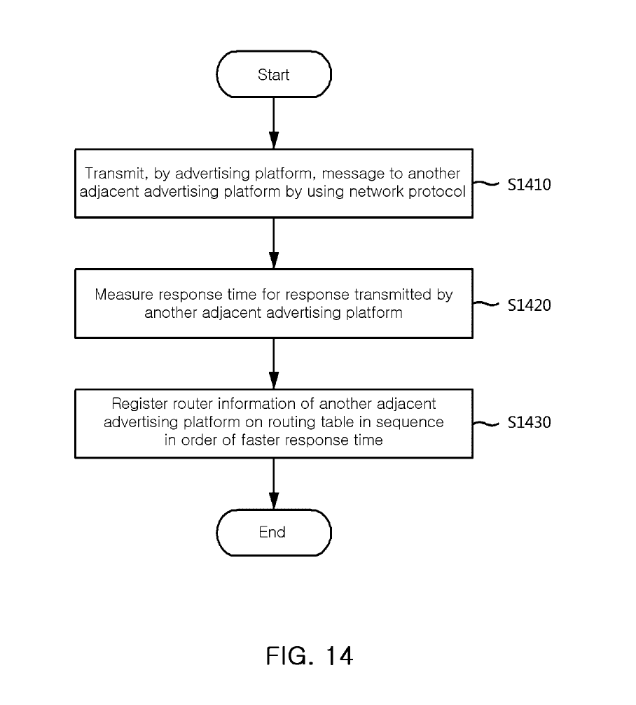

FIG. 14 is a flowchart illustrating a method of arranging a routing table by an advertising platform according to an embodiment of the present invention.

A method of arranging the routing table by the advertising platform 700 of the present invention includes (1) transmitting a message, (2) measuring a response time, and (3) registering router information.

That is, the method of arranging the routing table by the advertising platform 700 includes (1) transmitting a message to another adjacent advertising platform 700 by the advertising platform 700 by using a network protocol (S1410), (2) measuring a response time for a response transmitted by another adjacent advertising platform 700 with respect to the message transmitted in step (1) (alternatively, step S1410) (S1420), and (3) registering sequentially router information of another adjacent advertising platform 700 on a routing table in order that the response time transmitted in step (2) (alternatively, step S1420) is fast (S1430).

In step (1) (alternatively, step S1410), the advertising platform 700 transmits the message to another adjacent advertising platform 700 by using the network protocol.

In step (2) (alternatively, step S1420), the response time for a response transmitted by another adjacent advertising platform 700 is measured with respect to the message transmitted in step (1) (alternatively, step S1410).

In step (3) (alternatively, step S1430), the router information of another adjacent advertising platform 700 is sequentially registered on a routing table in order that the response time transmitted in step (2) (alternatively, step S1420) is fast.

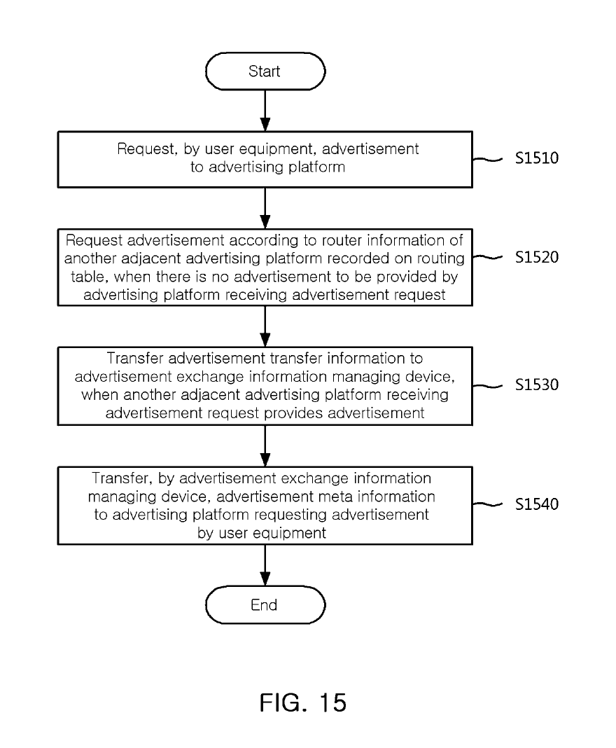

FIG. 15 is a flowchart illustrating a method of exchanging an advertisement between advertising platforms according to an embodiment of the present invention.

A method of exchanging the advertisement between the advertising platforms 700 of the present invention includes (1) requesting an advertisement for the advertising platforms 700, (2) requesting the advertisement for another advertising platform 700, and (3) transferring advertisement meta information.

That is, a method of exchanging the advertisement between the advertising platforms 700 includes (1) requesting the advertisement to the advertising platform 700 by the user equipment 500 (S1510), (2) requesting the advertisement according to the router information of another adjacent advertising platform 700 recorded on the routing table when there is no advertisement which may be provided by the advertising platform 700 receiving the advertisement request in step (1) (alternatively, step S1510) (step S1520), (3) transferring advertisement transfer information to the advertisement exchange information managing device 800 when another adjacent advertising platform 700 receiving the advertisement request in step (2) (alternatively, step S1520) may provide the advertisement (step S1530), and (4) transferring the advertisement meta information to the advertising platform 700 in which the user equipment 500 requests the advertisement by the advertisement exchange information managing device 800 (step S1540).

In step (1) (alternatively, step S1510), the user equipment 500 request the advertisement to the advertising platform 700.

In step (2) (alternatively, step S1520), when there is no advertisement which may be provided by the advertising platform 700 receiving the advertisement request in step (1) (alternatively, step S1510), the user equipment 500 request the advertisement according to the router information of another adjacent advertising platform 700 recorded on the routing table.

In step (3) (alternatively, step S1530), when another adjacent advertising platform 700 receiving the advertisement request in step (2) (alternatively, step S1520) may provide the advertisement, the user equipment 500 transfers advertisement transfer information to the advertisement exchange information managing device 800.

In step (4) (alternatively, step S1540), the advertisement exchange information managing device 800 transfers the advertisement meta information to the advertising platform 700 in which the user equipment 500 requests the advertisement.

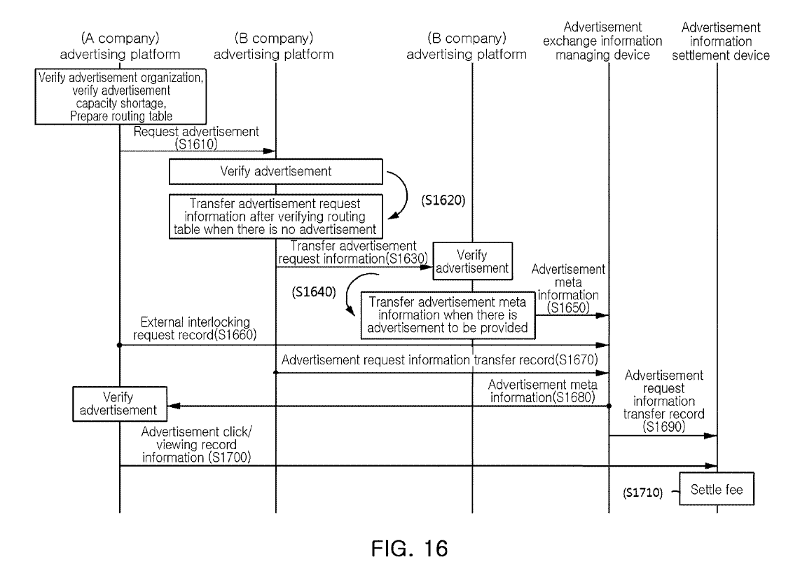

FIG. 16 is a flowchart illustrating a method of providing an advertisement exchange service between advertising platforms according to an embodiment of the present invention.

A method of providing an advertisement exchange service between advertising platforms 700 of the present invention includes (1) requesting an advertisement, (2) verifying the advertisement, (3) transferring advertisement request information, (4) verifying the advertisement, (5) transferring advertisement meta information, (6) transferring an external interlocking request record, (7) transferring an advertisement request information transfer record, (8) transferring advertisement meta information, (9) transferring an advertisement request information transfer record, (10) transferring advertisement click and viewing record information, and (11) settling a fee.

That is, the method of providing the advertisement exchange service between the advertising platforms 700 includes (1) requesting an advertisement to another advertising platform 700 by the advertising platform 700 (S1610), (2) verifying whether the advertisement is not present in another advertising platform 700 (S1620), (3) transferring advertisement request information to the advertising platform 700 according to router information recorded on the routing table when there is no advertisement to be provided in step (2) (alternatively, step S1620) (S1630), (4) verifying whether there is the advertisement to be provided to the advertising platform 700 according to the router information recorded on the routing table, (5) transferring advertisement meta information to the advertisement exchange information managing device 800 when there is the advertisement to be provided in step (4) (alternatively, step S1640) (S1650), (6) transferring an external interlocking request record of the advertising platform 700 first requesting the advertisement in step (1) (alternatively, step S1610) to the advertisement exchange information managing device 800 (S1660), (7) transferring an advertisement request information transfer record to the advertisement exchange information managing device 800 by the advertising platform 700 receiving the advertisement request information from the advertising platform 700 first requesting the advertisement in step (2) (alternatively, step S1620) (S1670), (8) transferring the advertisement meta information received by the advertisement exchange information managing device 800 in step (5) (alternatively, step S1650) to the advertising platform 700 first requesting the advertisement in step (1) (alternatively, step S1610) (S1680), (9) transferring an advertisement request information transfer record received by the advertisement exchange information managing device 800 in step (7) (alternatively, step S1670) to the advertisement information settlement device 900 (S1690), (10) transferring record information of clicking and viewing the providing advertisement to the advertisement information settlement device 900, in the advertisement provided by the advertising platform 700 first requesting the advertisement according to the advertisement meta information transferred in step (8) (alternatively, step S1680) (S1700), and (11) settling a fee by using the click or viewing record information received in step (10) (alternatively, step S1700) by the advertisement information settlement device 900 (S1710).

In step (1) (alternatively, step S1610), the advertising platforms 700 requests an advertisement to another advertising platform 700. The user equipment 500 requests the advertisement to another advertising platform 700 when there is no advertisement to be provide to the advertising platform 700 (the first advertising platform 700) requesting the advertisement.

In step (2) (alternatively, step S1620), whether the advertisement is not present in another advertising platform 700 is verified. In this case, in addition to only whether the advertisement is present, even though the advertisement is present, when the size of the corresponding advertisement, that is, UX/UI of the medium is not suitable, it may be verified that there is no advertisement.

In step (3) (alternatively, S1630), when there is no advertisement to be provided in step (2) (alternatively, step S1620), advertisement request information is transferred to the advertising platform 700 according to router information recorded on the routing table. The router information recorded on the routing table means router information of adjacent advertising platforms 700, and the router information is not just arranged according to the advertising platforms 700 having closer adjacent distances, but arranged and stored in order of the advertising platforms 700 having the most rapid response time on the adhoc network. The advertisement request information may be transferred according to the router information of the advertising platform 700 which is written on the top of the routing table.

In step (4) (alternatively, step S1640), whether there is the advertisement to be provided to the advertising platform 700 is verified according to the router information recorded on the routing table. In this case, like step (1) (alternatively, step S1610), in addition to only whether the advertisement is present, even though the advertisement is present, when the size of the corresponding advertisement, that is, UX/UI of the medium is not suitable, it may be verified that there is no advertisement.

In step (5) (alternatively, step S1650), when there is the advertisement to be provided in step (4) (alternatively, step S1640), advertisement meta information is transferred to the advertisement exchange information managing device 800.

In step (6) (alternatively, step S1660), an external interlocking request record of the advertising platform 700 first requesting the advertisement in step (1) (alternatively, step S1610) is transferred to the advertisement exchange information managing device 800. Herein, the external interlocking request record means a record requesting interlocking to the other advertising platform 700.

In step (7) (alternatively, step S1670), the advertising platform 700 receiving the advertisement request information from the advertising platform 700 first requesting the advertisement in step (2) (alternatively, step S1620) transfers an advertisement request information transfer record to the advertisement exchange information managing device 800. Herein, the advertisement request information transfer record means a record that the initial advertisement request information is transferred to the other advertising platform 700 when the advertising platform 700 requests the advertisement to the other advertising platform 700, for example, the transfer content when a first advertising platform 700 requests the advertisement to a second advertising platform 700.

In step (8) (alternatively, step S1680), the advertisement exchange information managing device 800 transfers the advertisement meta information received in step (5) (alternatively, step S1650) to the advertising platform 700 first requesting the advertisement in step (1) (alternatively, step S1610).

In step (9) (alternatively, step S1690), an advertisement request information transfer record received by the advertisement exchange information managing device 800 in step (7) (alternatively, step S1670) is transferred to the advertisement information settlement device 900.

In step (10) (alternatively, step S1700), in the advertisement provided by the advertising platform 700 first requesting the advertisement according to the advertisement meta information transferred in step (8) (alternatively, step S1680), record information of clicking and viewing the providing advertisement is transferred to the advertisement information settlement device 900.

In step (11) (alternatively, step S1710), the advertisement information settlement device 900 settles a fee by using the click or viewing record information received in step (10) (alternatively, step S1700). The advertisement exchange information managing device 800 transfers the advertisement transfer information to the advertisement information settlement device 900 and then the advertisement transfer information is used as data of settlement to be generated later. When the advertisement is exposed on the medium, the exposed advertisement information is transferred to the advertisement information settlement device 900. The exposed advertisement information may be advertisement click information or viewing record information. The advertisement information settlement device 900 performs the settlement through the settlement API call between the advertising platforms by considering settlement rates when verifying whether the information received from the advertisement exchange information managing device 800 before is present.

In this case, the advertising platform 700, the advertisement exchange information managing device 800, and the advertisement information settlement device 900 are connected to a wired/wireless communication network, and in this case, the communication network includes a base station controller, base station transmitter and/or repeater, and the like. Herein, the base station controller serves to relay a signal between the base station transmitter and an exchange station.

The communication network supports both a synchronous type and an asynchronous type. Accordingly, in the case of the synchronous type, a transmitting and receiving base station transmitter may be a base station transmission system (BTS) and a transmitting and receiving base station controller may be a base station controller (BSC), and in the case of the asynchronous type, the transmitting and receiving base station transmitter may be a radio transceiver subsystem (RTS) and the transmitting and receiving base station controller may be a radio network controller (RNC). Of course, the communication network according to the embodiment of the present invention is not limited thereto, and may be collectively used to a GSM network other than a CDMA network and an access network of a next-generation mobile communication system to be implemented later.

The communication network may further include access points. The access points represent small base stations such as femto or pico base stations installed in the building. Herein, the femto or pico base stations are classified according to how many servers and devices of the small base stations on the classification can be accessed. Further, the access point includes a short-range communication module for performing short-range communication such as WiFi with a potable terminal. The short-range communication may be performed in various standards such as Bluetooth communication, zigbee communication, infrared communication (IrDA), radio frequency (RF) such as ultra-high frequency (UHF) and very high frequency (VHF), and ultra-wideband wireless (UWB) communication. The access point extracts a location of a data packet, designates the best communication path for the extracted location, and transfers the data packet to the next device, for example, the user equipment 500 through the designated communication path. The access points may share several lines in a general network environment.

The access points are largely classified into fixed access points and mobile access points. The fixed access points may include a router, a repeater, a relayer, and the like, and the mobile access points include bridge products of a particular manufacturer such as egg of KT. The mobile access point reads a reception-side address in transmission-side information to designate and transmit the most appropriate communication path while ensuring free mobility.

In the present invention, the device and the server have a transceiving unit, and herein, the transceiving unit includes an RF transmission unit up-converting and amplifying a frequency of a transmitted signal and an RF reception unit low-noise-amplifying a received signal and down-converting the frequency, and the like. The transceiving unit may include at least one of a wireless communication module (not illustrated) and a wired communication module (not illustrated). In addition, the wireless communication module may include at least one of a wireless local area network (WLAN) (alternatively, Wi-Fi, wireless fidelity, or WiMAX, Worldwide Interoperability for Microwave Access) communication module and a wireless personal area network (WPAN) communication module.

The wireless communication module is a configuration for transceiving data according to the wireless communication method, and when the device and the server uses the wireless communication, data for providing payment information may be transmitted and received by using any one of the wireless network communication module, the WLAN communication module, and the WPAN communication module.

Meanwhile, the user equipment 500 may include a user equipment display unit (alternatively, a display unit) 530 displaying the advertisement transferred from the advertising platform 700.

In this case, the display unit may be configured in a touch screen form, and as such, when the display unit is configured in the touch screen form, the display unit may perform some or all of functions of the input unit. Particularly, the display unit according to the embodiment of the present invention may display the advertisement of the advertising platform 700 requested by the user equipment 500 or the advertisement information provided by the adjacent advertising platform 700.

As such, the advertising platform 700 of the present invention may provide the native advertising in a range without damaging a form and a function of its medium and exchange the native advertising between the advertising platforms 700 in the range without damaging the form and the function of its medium. In addition, the advertising platform 700 can ensure behavior information in the advertising platform without using agreement of information application of the user in order to a user behavior analysis for providing the advertisement.

Further, the advertisement may be exchanged between the advertising platforms by using an adhoc-network and the settlement may be performed through the API call between the advertising platforms 700.

The method of exchanging the advertisement between the advertising platforms 700 may be created by a program and codes and code segments configuring the program may be easily inferred by a programmer in the art.

Further, the program for the method of exchanging the advertisement between the advertising platforms 700 may be stored in readable media readable by electronic devices and read and executed by the electronic devices.

In the embodiment of the present invention, as described above, it is possible to improve operating efficiency of the advertising system according to a simple protocol, by providing advertisement information and a unique identifier of the advertisement information corresponding to a landing address to the user equipment, instead of directly transmitting the landing address together with the advertisement information to the user equipment requesting an advertisement.

Further, it is possible to protect the user equipment from modification of the advertisement information or infection of the malicious code through hacking by preventing the landing address from being exposed through the advertisement information and provide advertisement information having high reliability, by transmitting a selected unique identifier of the advertisement information when the unique identifier of the advertisement information is selected in the corresponding user equipment to the log storing and landing service providing device, and redirecting the corresponding user equipment from the corresponding log storing and landing service providing device to the landing address corresponding to the unique identifier of the advertisement information.

Further, it is possible to naturally provide the advertisement according to a medium in an application by providing native advertising in a range without damaging a form and a function of its medium of the advertising platform.

Further, it is possible to solve an advertisement shortage of each advertising platform by exchanging native advertising in a range without damaging a form and a function of its medium between advertising platforms.

Further, the advertising platform can ensure behavior information in the advertising platform, without using user's agreement to information application for a user behavior analysis for providing the advertisement in the advertising platform.

Further, it is possible to exchange the advertisement, by using an adhoc-network between the advertising platforms. Further, it is possible to perform settlement through settlement API call between the advertising platforms.

The technical features described in this specification and implemented components executing the technical features can be implemented by digital electronic circuits, implemented by computer software, firmware, or hardware including the structures described in this specification and structural equivalents thereof, or implemented by combinations of one or more thereof.

Further, the implemented component executing the technical features described in this specification may be implemented as a computer program product, that is, a module for a computer program command encoded on various types of program storage media for controlling the operation of the processing system and executing therefor.

A non-transitory computer readable storage medium may be a machine-readable storage device, a machine-readable storage substrate, a memory device, a machine-readable composition affecting a wave-type signal, or a combination of one or more thereof.

Meanwhile, in this specification, the “device” or “system” includes all equipment, devices, and machines for processing data including for example, a processor, a computer, or a multiple processor or computer.

The processing system may include all codes which form an execution environment for the computer program when requesting, for example, codes configuring processor firmware, protocol stack, a database managing system, an operating system, a combination of one or more thereof, or the like.

The computer program known as a program, software, a software application, a script, a code, or the like may be created in any form of compiled or interpreted language or programming language including priori and procedural language, and implemented in any form including other units suitable to be used in an independent program or module, a component, a subroutine, or a computer environment.

Meanwhile, the computer program does not necessarily correspond to a file of a file system, and may be stored in a single file provided to the requested program or a multiple interaction file (for example, a file which stores some of one or more modules, sub-programs, or codes), or a part of a file that holds other programs or data (for example, one or more scripts stored in a markup language document).

The computer program may be implemented to be positioned at one site or distributed over a plurality of sites to be executed on multiple computers or one or more computers interconnected by wired/wireless communication networks.

Meanwhile, a medium which is readable by a computer suitable for storing computer program commands and data may include all types of non-volatile memories, media and memory devices including for example, semiconductor memory devices such as EPROM, EEPROM, and flash memory devices, for example, magnetic disks such as internal hard disks and external disks, magnetic optical disks and CD and DVD disks. The processor and the memory may be supplemented by a special-purpose logic circuit or incorporated therein.

The implemented components which execute the technical features described in this specification include backend components such as data servers or for example, middleware components such as application servers.

For example, the implemented components may be implemented in an operation system including all combinations of one or more of front-end components or such backend, and middleware or front-end component such as a client computer having a web browser or a graphic user interface which the user may interact with the implemented component of the subject described in this specification. The component of the system can be interconnected by any form or medium of digital data communication such as a communication network.

Hereinafter, in addition to the described contents, a more particular embodiment which may implement configurations included in the system described in this specification and a method of providing benefits based on an MO service will be described in detail.

The system described in this specification and the method of exchanging the advertisement between the advertising platforms 700 may be partially or entirely used through a means which executes computer software, program codes or commands on a client device, a server related with or a web-based storage system or one or more processors included in the server.

Herein, the processor may be a part of computing platforms such as a server, a client, a network infrastructure, a mobile computing platform, and a stationary computing platform, and particularly, may be one kind of computer or processing device which may execute program commands, codes, and the like.

Further, the processor may further include a memory which stores the method of exchanging the advertisement between the advertising platforms 700, the command, the code, and the program. In addition, in the case where the memory is not included, the processor may also access a storage device such as a CD-ROM, a DVD, a memory, a hard disk, a flash drive, a RAM, a ROM, and a cache in which the advertisement between the advertising platforms 700, the command, the code, and the program are stored.

Further, the system described in this specification and the method of exchanging the advertisement between the advertising platforms 700 may be partially or entirely used through a server, a client, a gateway, a hub, a router, or a device which executes computer software on network hardware.

Herein, the software may be executed in various kinds of servers such as a file server, a print server, a domain server, an internet server, an intranet server, a host server, and a distributed server, and the aforementioned servers may further include interfaces which may access a memory, a processor, a non-transitory computer readable storage medium, a storage medium, a communication device, a port, and a client, and other servers via the wired/wireless network.

Further, the method of exchanging the advertisement between the advertising platforms 700, the command, the code, and the like may also be executed by the server, and other devices required for executing the method of exchanging the advertisement between the advertising platforms 700 may be implemented as a part of a hierarchical structure associated with the server.

Further, the server may provide an interface to other devices including clients, other servers, printers, database servers, print servers, file servers, communication servers, distributed servers, and the like without limitation and the connection through the interface may facilitate remote execution of the program through the wired/wireless network.

Further, any one of devices connected to the server through the interface may further include at least one storage device which may stores the method of exchanging the advertisement between the advertising platforms 700, the command, the code, and the like, and a central processor of the server provides commands and codes to be executed on different devices to be stored in the storage device.

Meanwhile, the system described in this specification and the method of exchanging the advertisement between the advertising platforms 700 may be partially or entirely used through a network infrastructure.

Herein, the network infrastructure may include devices such as computing devices, servers, routers, hubs, firewalls, clients, personal computers, communication devices, and routing devices and separate modules which may execute functions thereof, and further include a storage medium such as a storage flash memory, a buffer, a stack, a RAM, and a ROM in addition to the aforementioned devices and modules.

Further, the method of exchanging the advertisement between the advertising platforms 700, the command, the code, and the like may also be executed and stored by any one of a device, a module, and a storage medium included in the network infrastructure the server, and other devices required for executing the method of exchanging the advertisement between the advertising platforms 700 may be implemented as a part of the network infrastructure.

Further, the system described in this specification and the method of exchanging the advertisement between the advertising platforms 700 may be implemented by hardware or a combination of hardware and software suitable for a specific application. Herein, the hardware includes all of general-purpose computer devices such as personal computers and mobile communication terminals and enterprise specific computer devices. The computer device may be implemented by devices including a memory, a microprocessor, a microcontroller, a digital signal processor, an application integrated circuit, a programmable gate array, a programmable array organization, and the like or a combination thereof.

The computer software, the command, and the code described above may be stored and accessed by the readable device. Herein, the readable device may include a computer component including digital data used in computing at a predetermined interval, and a semiconductor storage such as a RAM or a ROM, a permanent storage such as an optical disk, a mass storage such as a hard disk, a tape, and a drum, an optical storage such as a CD or a DVD, a mass storage detachable from the computer such as a flash memory, a floppy disk, a magnetic tape, a paper tape, an independent RAM disk, and a network connection type storage such as a dynamic memory, a static memory, a variable storage, and a cloud.

Meanwhile, herein, the command and the code includes all languages such as data-oriented languages such as SQL and dBase, system languages such as C, Objective C, C++, and assemble, architecture languages such as Java, NET, and application languages such as PHP, Ruby, Perl, Python, but are not limited thereto, and may include all languages which are widely known by those skilled in the art.

Further, the “non-transitory computer readable storage medium” described in this specification includes all media contributing in providing commands for executing the program to the processor. Particularly, the non-transitory computer readable storage medium includes a non-volatile medium such as a data storage device, an optical disk, and a magnetic disk, a volatile medium such as a dynamic memory, and a transmission medium such as a coaxial cable, a copper wire, and an optical fiber, but the present invention is not limited thereto.

As an example, the non-transitory computer readable storage medium may be used to store and transfer RAM, ROM, EPROM, CD-ROM or other optical disk storage devices, a magnetic disk storage device or other magnetic storage devices, or any program code means in a form of a computer-executable command, a non-transitory computer readable command, or a data structure. The non-transitory computer readable storage medium may include physical storage media such as any other media which may be accessed by a general or special-purpose computer system, but is not limited thereto.

In description and claims below, the “network” is defined as one or more data links which may transmit electronic data between computer systems and/or modules. When the information is transmitted or provided to the computer system through the network or another communication access (wired, wireless, or a combination of wired and wireless), the access may be understood as a non-transitory computer readable storage medium.

The non-transitory computer readable commands include commands and data which allow the general computer system or the special-purpose computer system to perform a specific function or a function group. The computer-executable commands may be, for example, binary and intermediate format commands such as assemble or even source codes.

Furthermore, the present invention may be implemented in a network computing environment having various types of computer system configurations including a personal computer, a laptop computer, a hand-held device, a multiprocessor system, microprocessor-based or programmable consumer electronics, a network PC, a minicomputer, a mainframe computer, a mobile phone, a PDA, a pager, and the like. The present invention may also be executed in a distributed system environment in which local and remote computer systems linked with a wired data link, a wireless data link, or a combination of wired or wireless data links through the network perform a task. In the distributed system environment, the program module may be positioned in the local and remote memory storage devices.

Meanwhile, the configurations that execute the technical features of the present invention included in the block diagram and the flowchart illustrated in the accompanying drawing in this specification means a logical boundary between the configurations.

However, according to the embodiment of the software or the hardware, the illustrated configurations and the functions thereof are executed in a standalone software module, a monolithic software structure, a code, a service, and a combination thereof, stored in a computer-executable medium including a processor capable of executing stored program codes, commands, or the like and thus the functions thereof may be implemented. As a result, all of the embodiments need to belong to the scope of the present invention.

Accordingly, the accompanying drawings and the description thereof describe the technical features of the present invention, but a specific arrangement of software for implementing the technical features is not simply deduced unless clearly stated.

That is, various embodiments described above may be present, and the embodiments may be partially modified while holding the same technical features as the present invention, and thus need to be included in the scope of the present invention.

Further, in the case of the flowchart, operations are illustrated in the drawing in a specific order, but the flowchart is illustrated for obtaining the most preferable result. It should be not understood that the operations are necessarily executed in the illustrated specific order or a sequential order or all of the illustrated operations are necessarily executed. In a specific case, multi-tasking and parallel processing may be advantageous.

Furthermore, it should not be understood that the separation of various system components having the embodiment forms described above is required in all of the embodiments, and it should be understood that the described program components and systems may be generally integrated as a single software product together or packaged in a multiple software product.

The present invention can protect user equipment from modification of advertisement information or infection with malicious codes through hacking and provide advertisement information having reliability so as not to expose a landing address through the advertisement information, by providing advertisement information and a unique ID of the advertisement information corresponding to a landing address to the user equipment, instead of directly transmitting the landing address together with the advertisement information to the user equipment requesting an advertisement, transmitting a selected unique ID of the advertisement information when the unique ID of the advertisement information is selected in the corresponding user equipment to the log storing and landing service providing device, and redirecting the corresponding user equipment from the corresponding log storing and landing service providing device to the landing address corresponding to the unique ID of the advertisement information. Thus, the present invention can be widely used in an advertising field, a service providing apparatus field, a user equipment field, and the like.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

What is claimed is:

1. An advertising system controlling access to a landing page, the advertising system comprising:
an advertisement database storing a plurality of advertisement information;
an advertisement scheduling service providing device which matches a landing address for advertisement information with a unique ID of the advertisement information corresponding to advertisement information stored in the advertisement database, stores the matched landing address for each unique ID in a landing address cache database, and transmits advertisement volume information, the plurality of advertisement information, and unique IDs for the plurality of advertisement information;
an advertisement transmission service providing device which stores the advertisement volume information, the plurality of advertisement information, and the unique IDs for the plurality of advertisement information which are transmitted from the advertisement scheduling service providing device and transmits, to the user equipment, one or more advertisement information among the plurality of prestored advertisement information and unique IDs corresponding to the one or more advertisement information in response to an advertisement request signal transmitted from the user equipment;
user equipment which displays one or more advertisement information and unique IDs corresponding to the one or more advertisement information, respectively, which are transmitted from the advertisement transmission service providing device in response to the advertisement request signal and transmits a selected unique ID of the specific advertisement information and identification information of the user equipment when a unique ID of specific advertisement information is selected from the unique IDs corresponding to the one or more advertisement information; and
a log storing and landing service providing device which redirects the user equipment to the landing address corresponding to the unique ID of the specific advertisement information transmitted from the user equipment by interlocking with the landing address cache database.

2. The advertising system controlling access to a landing page according to claim 1, wherein the advertisement transmission service providing device verifies one or more advertisement information based on predetermined advertisement scheduling information among the plurality of prestored advertisement information, verifies a unique ID corresponding to each of the verified one or more advertisement information, and transmits the verified one or more advertisement information and the unique ID corresponding to each of one or more advertisement information to the user equipment.

3. The advertising system controlling access to a landing page according to claim 1, wherein the log storing and landing service providing device verifies the landing address corresponding to the unique ID of the specific advertisement information which is transmitted from the user equipment among the landing addresses for the plurality of unique IDs prestored in the landing address cache database.

4. The advertising system controlling access to a landing page according to claim 3, wherein the log storing and landing service providing device redirects the user equipment to the verified landing address to access the user equipment to an advertiser service providing device corresponding to the landing address.

5. A control method for an advertising system controlling access to a landing page, the control method comprising:
matching, by an advertisement scheduling service providing device, a landing address for advertisement information with a unique ID of the advertisement information corresponding to advertisement information stored in the advertisement database;
storing, by the advertisement scheduling service providing device, the matched landing address for each unique ID in a landing address cache database;
transmitting, by the advertisement scheduling service providing device, advertisement volume information, the plurality of advertisement information, and unique IDs for the plurality of advertisement information;
storing, by an advertisement transmission service providing device, the advertisement volume information, the plurality of advertisement information, and the unique IDs for the plurality of advertisement information which are transmitted from the advertisement scheduling service providing device;
transmitting, by the advertisement transmission service providing device, to the user equipment, one or more advertisement information among the plurality of prestored advertisement information and unique IDs corresponding to the one or more advertisement information in response to an advertisement request signal transmitted from the user equipment; and
displaying, by the user equipment, one or more advertisement information and unique IDs corresponding to the one or more advertisement information, respectively, which are transmitted from the advertisement transmission service providing device in response to the advertisement request signal.

6. The control method for an advertising system controlling access to a landing page according to claim 5, further comprising:
transmitting, by the user equipment, a selected unique ID of the specific advertisement information and identification information of the user equipment when a unique ID of specific advertisement information is selected from the unique IDs corresponding to the one or more advertisement information; and
redirecting, by a log storing and landing service providing device, the user equipment to the landing address corresponding to the unique ID of the specific advertisement information transmitted from the user equipment by interlocking with the landing address cache database.

7. The control method for an advertising system controlling access to a landing page according to claim 6, wherein the transmitting of the one or more advertisement information and unique IDs corresponding to the one or more advertisement information, respectively, to the user equipment includes:
verifying, by the advertisement transmission service providing device, one or more advertisement information based on predetermined advertisement scheduling information among the plurality of prestored advertisement information;
verifying, by the advertisement transmission service providing device, a unique ID corresponding to each of the verified one or more advertisement information; and
transmitting, by the advertisement transmission service providing device, to the user equipment, the verified one or more advertisement information and the unique ID corresponding to each of the one or more advertisement information.

8. The control method for an advertising system controlling access to a landing page according to claim 6, wherein the redirecting of the user equipment includes:
verifying, by the log storing and landing service providing device, the landing address corresponding to the unique ID of the specific advertisement information which is transmitted from the user equipment among the landing addresses for the plurality of unique IDs prestored in the landing address cache database; and
redirecting, the log storing and landing service providing device, the user equipment to the verified landing address to access the user equipment to an advertiser service providing device corresponding to the landing address.

9. A non-transitory computer readable storage medium having a computer program recorded therefor performing the method of claim 5.

10. A non-transitory computer readable storage medium having a computer program recorded therefor performing the method of claim 6.

11. An advertising platform, comprising:
an advertising platform information registering unit which arranges router information for another adjacent advertising platform according to a predetermined priority to register the router information on a routing table;
an advertisement request information receiving unit which receives advertisement request information from the other advertising platform; and
an advertisement providing unit which provides the advertisement to user equipment according to the advertisement request information.

12. The advertising platform according to claim 11, further comprising:
an advertisement destination comparing unit which compares an advertisement transfer destination and departure point between the advertising platforms;
an advertisement verifying unit which verifies whether there is an advertisement to be provided according to the advertisement request information received from the advertisement request information receiving unit;
an advertisement request information transferring unit which transfers the advertisement request information to another advertising platform; and
an advertisement transfer information transmitting unit which transmits the information transferred by the advertisement request information transferring unit to an advertisement exchange information managing device.

13. The advertising platform according to claim 11, wherein the advertising platform is connected with another adjacent advertising platform by an adhoc-network.

14. The advertising platform according to claim 12, wherein the advertising platform information registering unit registers router information of the other advertising platform on a routing table when a size of the advertisement held by the advertising platform requesting the advertisement coincides with a size of the advertisement held by the other advertising platform.

15. The advertising platform according to claim 14, wherein the advertising platform information registering unit registers the router information of another advertising platform on the routing table, when it is verified in the advertisement destination comparing unit that the transfer destination of the advertising platform and the departure point of the other advertising platform are not the same as each other.

16. The advertising platform according to claim 12, wherein the advertisement request information transferring unit transfers the advertisement request information to the other advertising platform according to the routing table priority when it is verified in the advertisement verifying unit that there is no advertisement to be provided.

17. The advertising platform according to claim 12, wherein the advertisement providing unit provides the advertisement according to the advertisement request information when it is verified in the advertisement verifying unit that there is the advertisement to be provided.

18. The advertising platform according to claim 17, wherein the advertisement providing unit provides the advertisement when a category value of the advertisement to be provided and a category value included in the user coincide with each other.

19. The advertising platform according to claim 17, wherein the advertisement providing unit provides the advertisement when a category value of the advertisement to be provided and a category value of a medium coincide with each other.

20. The advertising platform according to claim 11, wherein the advertising platform information registering unit measures network response times of other adjacent advertising platforms every predetermined period and sequentially registers router information of the other adjacent advertising platforms on the routing table according to the response time.
